(19) United States
(12) Patent Application Publication
(10) Pub. No.: US 2006/0095429 A1
(43) Pub. Date: May 4, 2006

(54) Networked system for routing medical images

(75) Inventors: Vishwas G. Abhyankar, Pittsford, NY (US); Richard Weil, Pittsford, NY (US)

Correspondence Address: Mark G. Bocchetti;Patent Legal Staff, Eastman Kodak Company, 343 State Street, Rochester, NY, 14650-2201, US

(73) Assignee: Eastman Kodak Company

(21) Appl. No.: 10/977,855

(22) Filed: Oct. 29, 2004

(51) Int. Cl. G06F 7/00

(52) U.S. Cl. 707/7

(57) ABSTRACT

A method for dynamically routing medical data related to a patient (12) in a communications network (16) obtains the medical data about the patient at a first site and obtains patient profile data having information associated with the patient (102). The patient profile data is processed to identify, from a plurality of available specialist sites, a receiving specialist site (118) for transmittal of the medical data, based on the patient profile data. The medical data is then transmitted to the receiving specialist site (130).

### FIELD OF THE INVENTION

This invention generally relates to networked systems for obtaining, evaluating, and managing medical data and more particularly relates to a system for routing medical image data over a network for remote screening and processing.

### BACKGROUND OF THE INVENTION

The advantages of network communication for transmission of diagnostic information about a patient from one site to the next have been acknowledged by medical practitioners. The capability for transfer of data and images from a test site to a specialist for assessment has enabled the growth of a number of new services for remote diagnosis. While network communication of such data has a number of benefits, there remain some drawbacks to wider acceptance and use of this capability. In terms of workflow, for example, conventional network communication schemes often impose restrictive procedures that are inflexible and are not well-suited to the varying needs of patients, primary care physicians (PCPs) or medical specialists. Moreover, changes in insurance coverage rules and local and federal regulations render such inflexible systems cumbersome to adapt and more vulnerable to obsolescence.

As one exemplary problem area of interest, there is considerable concern in the medical community that timely detection and treatment for diabetic retinopathy, macular degeneration, and other vision-related conditions are not being provided for a large percentage of patients who are affected by such debilitating conditions. Over time, diabetic retinopathy affects a majority of those who suffer from diabetes, often leading to severe vision impairment and blindness if not treated early. Accurate diagnosis of diabetic retinopathy requires the skills of a trained specialist, who views the retina of a patient to look for lesions and other evidence of this condition during a periodic examination. Currently, a high percentage of these examinations are made at the office of a specialist and are performed by the specialist or by trained staff members. More recently, various camera apparatus have been devised, especially designed for the type of fundus imaging needed for preliminary diagnosis, allowing a specialist to view images of the patient for diagnostic assessment. For example, U.S. Pat. No. 5,943,116 (Zeimer) discloses an optical system for obtaining the 7-image fundus series used for this type of diagnosis.

One notable problem with conventional methods for examination of patients relates to the cost and inconvenience to patients in visiting the ophthalmologist or optometrist. Statistics show, for example, that most diabetic patients visit their regular primary care physician (PCP) on at least an annual basis; but the number of these patients who also make an annual visit to an eye specialist is relatively low in comparison.

There have been a number of recent efforts to alleviate this problem and increase the compliance percentage of patients needing periodic examinations. One approach has been the development of imaging equipment that does not require specialists for operation. U.S. Pat. No. 5,943,116, for example, addresses the need for a lower cost fundus imaging system that can be operated by non-ophthalmic staff at the PCP office, and that obtains images without requiring dilation of the patient's eyes. Images obtained in this way can then be uploaded to a centralized image reading center for evaluation by trained technicians and specialists.

FIGS. 5 and 6 give a summary overview showing the impact of methods such as those of U.S. Pat. No. 5,943,116 on the overall diagnostic workflow. Referring to FIG. 5, there is shown the conventional workflow for diagnosis of a patient 12 who is at risk of diabetic retinopathy or other condition. Patient 12 visits primary care physician (PCP) 46 regularly. Where diagnostic assessment is deemed necessary, patient 12 is referred to a specialist 48, and must make a separate appointment to meet with specialist 48 for examination. FIG. 6 shows the change brought about using the methods of U.S. Pat. No. 5,943,116. Here, PCP 46 obtains medical images of the retina using a fundus camera apparatus 52. This device obtains the necessary series of fundus images and transmits them to a server 18 at a remote centralized reading center 50. Here, images obtained are processed, displayed, and analyzed using a control logic processor 38. Initial screening of patient 12 images is performed at reading center 50. Only those patients 12 who appear to need more detailed diagnosis are then referred to specialist 48.

The use of centralized reading center 50 for collecting and evaluating patient images, as described in U.S. Pat. No. 5,943,116, has a number of advantages for cost, efficiency, and more effective delivery of diagnostic services. There have been a number of commercial ventures established using this model. For example, Inoveon Corporation, Oklahoma City, Okla., USA provides networked diagnostic reading centers 50 for ophthalmic evaluation of retinal images for diabetic retinopathy. At reading center 50, non-physician technicians perform initial screening of images, with follow-up by medical specialists where problems are identified. Similarly, EyeTel Imaging, Inc., Centreville, Va., USA operates a central reading center 50 that is network-connected to physician's offices for obtaining images that can be remotely screened for diabetic retinopathy using fundus camera apparatus 52. Likewise, U.S. Pat. No. 5,993,001 (Bursell et al.) discloses a network-distributed system that allows a variable arrangement of image data collection units connected to a variable number of examination units for medical specialists, all accessed through a central server. Other patent disclosures that describe remote diagnostic imaging facilities include U.S. Patent Application Publication 2002/0052551 (Sinclair et al.); PCT International Application Nos. WO 96/017545 (Bursell et al.); WO 02/084511 (Yogesan); WO 03/020112 (Sinclair et al.); and U.S. Pat. No. 6,470,320 (Hildebrand et al.)

While diagnostic systems using remote, centralized reading centers provide a number of advantages, there are still perceived difficulties in providing the level of service and diagnostic accuracy needed for providing this vital function. Advantages of networked image transfer, high volume storage, and centralized data access can be readily acknowledged; however, there is an understandable reluctance among medical practitioners to adopt a new workflow for diagnostic evaluation simply because it takes advantage of these technological advances. In fact, as is shown in FIG. 6, specialist 48 can be bypassed altogether using the system described in U.S. Pat. No. 5,943,116. In some percentage of cases, this would likely be undesirable. Certainly, to make such a system more widely accepted, there must be a more flexible arrangement that is compatible with existing workflows and business arrangements and allows the participation of specialist 48, including sending images directly to specialist 48 in some cases.

In order to embrace the new methodology and workflow that this technology affords, specialists, physicians, patients, and insurance providers alike must have compelling evidence that accuracy, success rates, and overall performance of the system exceeds current methods for delivery of diagnostic services. Only when true improvements are obtained will remote diagnostic imaging systems be widely accepted as equivalent to any “gold standard” currently accepted by medical practitioners and service providers.

Among the perceived drawbacks of these new schemes for networked diagnostic imaging is the need to rearrange conventional workflow. This requirement impacts each participant in the process. For example, patients would be receptive to having screening examinations performed without the need to make a separate appointment with an eye specialist; however, the screening apparatus must be accurate and comfortable for the patient. Preferably, for example, a nonmydriatic imaging system, that is, one not requiring pupil dilation, would be preferred. Primary care physicians (PCPs) 46 would be receptive to performing the steps needed for obtaining screening images, provided the apparatus is easy to operate; certainly, the more easily operable the imaging system, the more attractive the procedure for PCPs 46. Ophthalmologists or other specialists 48 would be receptive to providing higher levels of service to their patient base, allowing them to focus on more complex diagnosis and treatment, rather than on screening services; however, the medical specialist 48 may want to preserve current workflow arrangements and must have a high degree of confidence in the overall performance and accuracy of the remote diagnostic imaging system. Insurance providers, who currently exhibit some caution concerning the accuracy and suitability of these remote diagnostic tools, would be receptive to methods that improve service to their subscribers while reducing costs. In addition, there must be conformance with applicable laws regarding the use of apparatus for obtaining, transmitting, and safeguarding diagnostic data.

In light of these complex requirements, existing networked diagnostic imaging systems, while offering the promise of improved service and performance, fall somewhat short of what is needed for broad acceptance of these systems. Some of the existing systems, for example, employ expensive camera equipment and require specialized operator training, adding cost and complexity. Existing systems are typically assembled and configured at the image capture site, which may be a PCP office. These systems can be costly to install, particularly where a service call is required for their connection and initial configuration. Imaging systems requiring administration for networking, software update, and the like place demands for training and retaining skilled staff members at a PCP office or test facility. In addition, a number of systems employing network image transfer require pupil dilation of patient 12, which is less desirable.

To date, image handling and workflow schemes that have been proposed and implemented for remote assessment of medical images have focused heavily on clinical processing and disease management. Early adopters of remote diagnostic imaging directed their efforts to obtaining accurate and efficient analysis of image content and subsequent diagnosis. However, while this is a worthwhile goal, a number of practical problems remain, preventing widespread implementation of networked diagnostic imaging schemes. For example, existing systems are characterized by a relative lack of flexibility in workflow. In many cases, the centralized reading center follows a fairly rigid workflow scheme, obtaining the patient image, performing a diagnostic assessment, and reporting information back to the attending physician, who may be a PCP or ophthalmic specialist. Understandably, some physicians 46 and specialists 48 balk at adopting a workflow that can be perceived to take work out of their control, without providing the option of their own oversight for verification. For example, specialist 48 may be willing to access patient images stored remotely, but be unwilling to accept diagnostic evaluations performed by technicians at central reading center 50. Or, specialist 48 may accept a “coarse” level of screening from reading center 50, but prefer closer, personal examination of images for patients who exhibit any type of perceived problem. Existing systems, however, are not amenable to adapt to the professional preferences of specialists 48 or PCPs 46 for providing different levels of service and access. As this example illustrates, existing systems appear to impose rigid workflows that can easily hamper their widespread acceptance by the medical community.

There has also been some resistance to networked diagnostic imaging from health insurers. Administrative complexities due to different plans, variable levels of coverage, and changing federal and state regulations hamper a broader adoption of remote diagnostic imaging simply because not all tests can be reimbursed for all patients under all health insurance programs. The accuracy of some types of remote testing remains in question and is expected to improve over time. In the meantime, however, the role of the health insurer has not been sufficiently taken into account with existing networked solutions. Similarly, employer stipulations and requirements have not been taken into account.

Conventional schemes for remote diagnostic assessment are also fairly inflexible with respect to reporting details. With most systems, the diagnostic assessment for a patient is reported back to the PCP for referral. However, there may be other parties requiring access to this information. For example, there may be cases where immediate referral to a specialist is needed; delay in the PCP office would not be desirable. Or, an insurance carrier may need access to the results, requiring the carrier to request them from the PCP office, with consequent delay and overhead costs. In addition, different levels of information might be needed for different parties to the treatment or reimbursement process.

An overall drawback of conventional remote diagnostic imaging or testing systems relates to the decision-making process that may be required once the images or other test data are obtained. Even if the test data is always routed to the same remote site for diagnosis, other reporting is necessary once the test results are obtained. The multiple and complex tasks of handling requests for different types of information from different insurance carriers, routing results to any of a number of specialists for further examination and/or treatment, maintaining patient files, and coordinating the transfer of information in accordance with privacy regulations, all may fall on the staff at the PCP office. If this is the case, it should not seem surprising that remote diagnostic systems have not been more broadly embraced and endorsed.

There is a compelling need for improving the delivery of medical treatment to patients, particularly those who have diabetic retinopathy, macular degeneration, and other debilitating conditions that affect vision. This need is particularly pronounced for patients over age 65, a growing part of the population. Early treatment of such conditions can help to preserve vision for millions of those who are at risk, with considerable concomitant savings in medical expense and costs of social services. This argues for any incremental improvement that helps to provide the benefits of remote diagnostic imaging services, particularly for vision-related conditions.

Thus, what is needed is a system for obtaining diagnostic data, obtaining routing criteria from patient, medical, and reimbursement sources, and routing the data according to routing instructions based on these routing criteria.

### SUMMARY OF THE INVENTION

It is an object of the present invention to provide an improved, more flexible workflow for networked diagnostic imaging systems, particularly those related to conditions of the eye. With this object in mind, the present invention provides method for dynamically routing medical data related to a patient in a communications network, comprising:
(a) obtaining the medical data about the patient at a first site;
(b) obtaining patient profile data comprising information associated with the patient;
(c) processing the patient profile data and identifying, from a plurality of available specialist sites, a receiving specialist site for transmittal of the medical data, based on the patient profile data; and
(d) transmitting the medical data to the receiving specialist site.

From another aspect, the present invention provides a system for providing a diagnosis for a patient comprising:
(a) an image capture appliance at a first networked site for obtaining retinal image data from the patient, for obtaining metadata about the patient, and for executing a network transaction for transmitting the retinal image data and metadata to a second networked site;
(b) a remote server in networked communication with the image capture appliance for obtaining the metadata for the patient and for providing the network address of the second site according to the metadata;
(c) a storage resource in communication with the remote server for storing a copy of the transmitted retinal image data; and
(d) a viewing appliance in networked communication with the remote server and in networked communication with the image capture appliance for viewing the transmitted retinal image data according to the routing instructions.

It is a feature of the present invention that it provides a rule-based workflow that takes into account different workflow arrangements for assessment of diagnostic data and images. Individualized rules can be applied to each patient account for dynamic routing of images or other diagnostic data using this scheme.

It is an advantage of the present invention that it allows a more flexible workflow for processing diagnostic data and images, taking into account the approval/reimbursement policies of health care insurers, the variable working practices of medical professionals, and patient preferences. Advantageously, the rule-based routing workflow can be changed as needed for any diagnostic data, without requiring interaction by office staff.

It is an advantage of the present invention that it provides an image capture appliance that is easily configured and easy to operate, able to accept remotely provided instructions for its operation. It is also an advantage of the present invention that it allows sending the data directly from the image capture appliance to a networked reading appliance.

It is a further advantage of the present invention that it provides a viewing appliance that allows medical images to be assessed at a remote site, without requiring extensive system administration activities for its configuration and use. It is also an advantage of the present invention that it allows reports based on diagnosis to be transmitted back to the viewing appliance site.

These and other objects, features, and advantages of the present invention will become apparent to those skilled in the art upon a reading of the following detailed description when taken in conjunction with the drawings wherein there is shown and described an illustrative embodiment of the invention.

### BRIEF DESCRIPTION OF THE DRAWINGS

While the specification concludes with claims particularly pointing out and distinctly claiming the subject matter of the present invention, it is believed that the invention will be better understood from the following description when taken in conjunction with the accompanying drawings, wherein:

FIG. 1 is a block diagram showing the components of a diagnostic imaging system according to the present invention;

FIG. 2 is a block diagram showing functional logic components of an appliance for image capture;

FIG. 3 is a logic flow diagram showing the sequence used for image routing from the site obtaining the medical images;

FIG. 4 is a logic flow diagram showing the sequence for generating and assigning routing instructions to patient data;

FIG. 5 is a process flow diagram showing the conventional workflow for patient diagnosis;

FIG. 6 is a process flow diagram showing conventional workflow for patient diagnosis using existing remote diagnosis systems;

FIG. 7 is an encoded example of a patient profile as used in the method of the present invention;

FIG. 8 is an encoded example of a PCP profile as used in the method of the present invention;

FIG. 9 is an encoded example of a specialist profile as used in the method of the present invention;

FIG. 10 is an encoded example of another specialist profile as used in the method of the present invention;

FIG. 11 is an encoded example of a health insurer profile as used in the method of the present invention;

FIG. 12 is an encoded example of a regulatory profile as used in the method of the present invention;

FIGS. 13A-13H show portions of an XML schema encoding for profiles shown in FIGS. 7-12 when incorporated as part of a workflow profile;

FIG. 14 is a graphical representation of the workflow profile example of FIGS. 13A-13H;

FIGS. 15A-15C is an example of portions of an XML schema for common data structure definitions employed in the schema of FIGS. 13A-13H; and

FIGS. 16A-16C show portions of an example XML encoding for a typical workflow profile according to the present invention.

### DETAILED DESCRIPTION OF THE INVENTION

The present description is directed in particular to elements forming part of, or cooperating more directly with, apparatus in accordance with the invention. It is to be understood that elements not specifically shown or described may take various forms well known to those skilled in the art.

The general term “profile” is used in subsequent description as it is often used to describe a structured body of information relative to a user account or to other entity in a computer or networked system. The method of the present invention takes advantage of a number of different types of profiles available at one or more sites on a networked system.

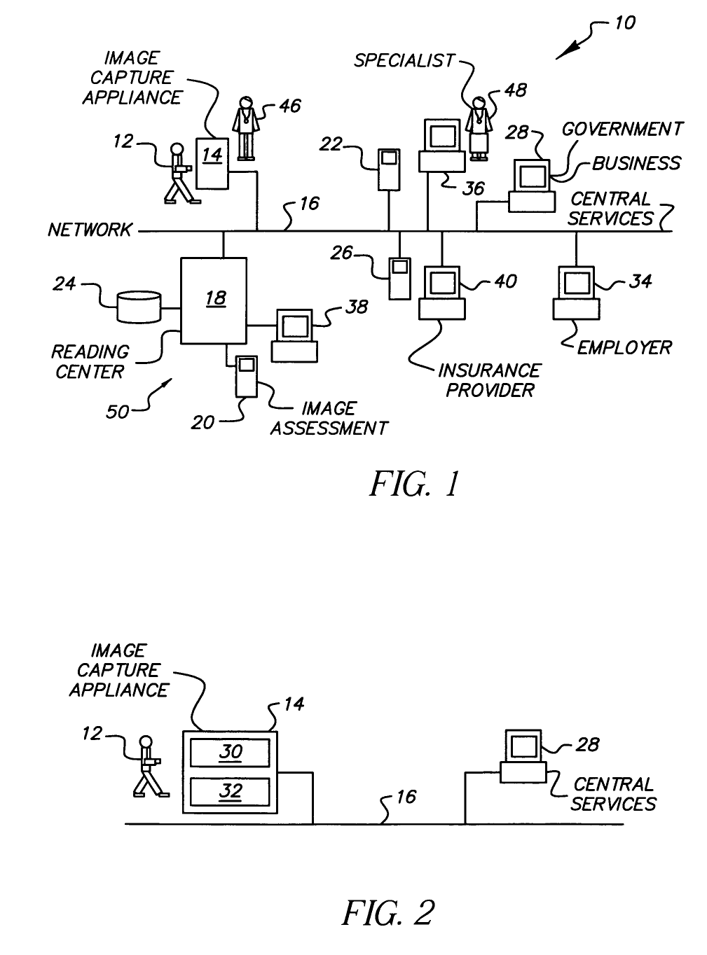

Referring to FIG. 1, there is shown a block diagram of a diagnostic imaging system 10 of the present invention for obtaining and processing retinal images from a patient 12. An image capture appliance 14 is provided for capturing one or more retinal images from patient 12 based on the type of diagnosis needed, such as diabetic retinopathy, for example. Image capture appliance 14 connects to a network 16, such as the Internet or some other communications network, including a high speed telecommunications connection, for example. Image capture appliance 14 may be installed at any type of primary care site, including a PCP office, the office of an ophthalmologist or optometrist or other specialist 48, or a general site that performs medical testing, such as an outpatient services laboratory, for example. This arrangement requires image that capture appliance 14 be easy to operate and, optimally, programmed for automatic operation.

It should be noted that the term specialist as used herein can be interpreted broadly to include a range of medical specialties. A grouping of specialists, such as a practice group, could also participate in the system and method of the present invention.

Connected along network 16 in the embodiment of FIG. 1 is at least one server 18 that can accept images from one or more image capture appliances 14. Server 18 may be, for example, a high-capacity network server configured as a web server. Server 18 is typically in communication with a reading appliance 20 at a centralized reading center 50. Server 18 cooperates with a database 24 and high-volume storage apparatus for maintaining a large quantity of patient images and data, serving multiple image capture appliances 14. In one embodiment, server 18 is a single function device.

Reading appliances 20, 22 for medical image assessment may be installed at a centralized reading center or at a specialist site. Additionally, reading appliances 26 may be installed at a health insurance provider's facility. In one embodiment, the function of reading appliance 20, 22, 26 is programmable, allowing controlled access to information at any point in network 16.

A central services processor 28 acts as a control center, performing access and functional administration functions for all sites that use diagnostic imaging system 10. With this system, central services processor 28 orchestrates, to some degree, the operation of each networked component, from installation and initial configuration to its day-to-day operation. Central services processor 28 communicates with logic processors 34, 36, 38, and 40 at various sites along the network to obtain information used to condition the routing function provided for patient diagnostic data or images and test results. Logic processors 34, 36, 38, and 40 could be conventional networked computers or dedicated systems for interface with diagnostic imaging system 10.

With the system arrangement of FIG. 1, as administered from central services processor 28, considerable flexibility is provided for routing of, and access to, patient medical images and other patient data, according to routing rules that can be dynamically generated, as described subsequently. Depending on specialist preference applied to a specific patient 12, for example, reading center 50 personnel may perform a complete assessment of the medical images, may perform some types of screening but not others, or may be bypassed altogether for viewing medical images for specific patients. Specialist 48 may choose to use or audit reading center results or choose to be notified only in the event that trained screening personnel detect a condition that warrants treatment by specialist 48. The insurance provider may also perform audits of reading center work at a local reading appliance 26, or may choose to function as a referring intermediary, referring only earmarked cases from the reading center to specialists 48, as it deems necessary.

Control of Image Capture Appliance 14

Referring to FIG. 2, there are shown functional processing components of image capture appliance 14. An image processor 30 provides the needed processing functions for obtaining the images from patient 12 and performing any necessary correction, calibration, or compression algorithms on the data obtained. A routing control processor 32 obtains information about how retinal images or other diagnostic data are to be captured, processed, and transmitted for each patient 12. Routing control processor 32 then participates in the routing of images or other data for patient 12, based on routing instructions that are provided from central services processor 28.

Image capture appliance 14 could be a networked computer workstation connected to a digital camera, as in a number of conventional networked diagnostic imaging system solutions. The preferred embodiment, however, employs a true “networked appliance” approach. The networked appliance is analogous to cable TV interconnect boxes that, to the end user, are merely “plug-in” devices, but actually include internal processors, memory, and software. Networked appliances of this type are addressable and remotely configured, with control software downloaded by the network control facility. With such an arrangement, the end user need not be concerned with complexities of making connections, passing commands and security permissions, or other data transactions when using such an appliance. In diagnostic imaging system 10, network control of this type of appliance is performed by central services processor 28. Using this model, when image capture appliance 14 is unboxed at installation, it merely needs to be plugged into the network, without extensive configuration by user personnel at the site. Central services processor 28 automatically scans and detects a newly connected image capture appliance 14 and configures the device accordingly upon detection. In one embodiment, image capture appliance 14 is configured as a device capable of executing Java code, or other interpreted code, downloaded through the network, under control of central services processor 28.

As is shown in FIG. 1, central services processor 28 may be separate from server 18. Alternately, the function of central services processor 28 could be performed from the same site and computer platform as server 18. It is instructive to emphasize that the function of central services processor 28 is different from the function of server 18, which has the primary functions of storage and of providing images to sites who require access.

Central services processor 28 also exercises control over image capture appliance 14 operation. When patient 12 is identified to image capture apparatus 14, instructions provided by central services processor 28 can be used to direct image capture apparatus 14 functions, including specifying the image sequence that is obtained, for example. Once images and other data are obtained, routing instructions from central services processor 28 can be used to dictate how images are processed and to specify one or more remote reading appliances 20, 22, 26 or one or more remote reading centers 50 to receive the images.

Using the networked appliance model, then, image capture appliance 14 operation can be streamlined, customized for the needs of each patient 12. This arrangement would help to assure that the proper image sequence or series of suitable tests is obtained for each patient 12, based on that patient's condition and history and based on applicable requirements or restrictions obtained from the health insurance provider. This arrangement also allows billing and other management functions to be performed automatically, minimizing confusion due to poor communication between office personnel at the PCP 46 and those at a specialist 48 or insurance provider office. This also reduces paperwork and text data entry at the PCP office or test site and can help to provide well-documented medical images and other data for further transmittal and assessment.

Control of Reading Appliance 20, 22, 26

The same type of configuration control exercised for image capture appliance 14 can also be applied to reading appliance 20, 22, 26 at a reading center, medical specialist facility, health insurance provider, or other site that is permitted to view medical images or other data obtained by diagnostic imaging system 10. Installation of reading appliance 22 at a specialist site, for example, is straightforward, using the same “plug-in” sequence that applies for image capture appliance 14 at the PCP site. Central services processor 28 detects a newly connected reading appliance 20, 22, 26 as soon as it is plugged into the network and configures the device accordingly.

In addition, central services processor 28 can perform any necessary software updates for reading appliances 20, 22, 26. This is advantageous, particularly where software is provided that assists diagnosis or performs other functions such as initial image quality assessment, for example. Reading appliances 20, 22, 26 may include diagnostic assessment utilities, enabling specialists to take advantage of image processing tools for more accurate diagnosis. Supporting software tools may be options, available to specialists or other viewers for an additional fee, for example.

In terms of ease of use, reading appliance 20, 22, 26 is necessarily more complex than image capture appliance 14 must be. Image viewing software, even with optional additional software to aid in diagnosis, requires some level of skill to operate effectively. However, the administration of these systems can be greatly streamlined using remote administration from central services processor 28.

Reading appliance 20, 22, 26 could be a conventional computer workstation, equipped with the specific software needed for image acquisition and assessment. This arrangement would allow specialist 48 to install reading software on a networked computer that is also used for other purposes. Optionally, reading appliance 20, 22, 26 could be a dedicated appliance following the networked appliance model as described above for image capture apparatus 14, not a platform intended for other functions.

Summary of Central Services Processor 28 Functions

The functions of central services processor 28, then, may include any or all of the following:
(a) configure a newly installed image capture apparatus 14;
(b) perform software updates for the existing base of image capture apparatus 14;
(c) provide instructions for image routing and processing based on patient profile information and on routing rules from other logic processors 28, 34, 36, 40 on the network;
(d) provide access control for reading appliances 20, 22, 26;
(e) configure a newly installed reading appliance 20, 22, 26;
(f) perform software updates for the existing base of reading appliances 20, 22, 26, including diagnostic utilities;
(g) provide billing information on system usage, with data specific for each site and each patient 12;
(h) provide optional software tools to individual sites, including supporting software utilities purchased at specific sites;
(i) maintain a link to data provided from insurance providers for patients at each site; and
(j) adjudicate conflicts in generating the routing instructions for diagnostic data or images for each patient 12.

The use of routing decisions from central services processor 28 also allows flexibility in how each site uses diagnostic imaging system 10. For example, where an insurance carrier requires that a certain series of images be obtained for patients 12 having a certain medical condition, central services processor 28 can be used to make sure that routing rules provide that this series be captured. Where a participating PCP 46 has staff that is skilled to perform only basic screening image capture procedure, central services processor 28 can control image capture apparatus 14 so that only this procedure is performed.

Routing rules and instructions from central services processor 28 can be downloaded as needed, either at periodic intervals or on a patient-by-patient basis, depending on the hardware configuration, frequency of use, differences in types of images obtained, and other factors. The operating instructions from one image capture apparatus 14 to the next and routing rules applied from one patient 12 to the next may vary, depending on specialist 48 or PCP 46 preferences, skill level of available personnel, patient 12 preferences, insurance provider coverage guidelines, employer requirements, or other appropriate factors.

For constructing routing rules, patient account information is made accessible to central services processor 28 from some source. The source of this information may be accessed through an insurance provider, for example. Server 18 may store patient account information; however, since this information often requires update, and because diagnostic imaging system 10 must interface with other medical data information systems, it is unlikely that storing this duplicated information in database 24, for example, would be prudent. Instead, some source feed (not shown in FIG. 1) would be needed for obtaining the latest patient 12 information, such as on an as-needed basis.

Routing of Patient Images

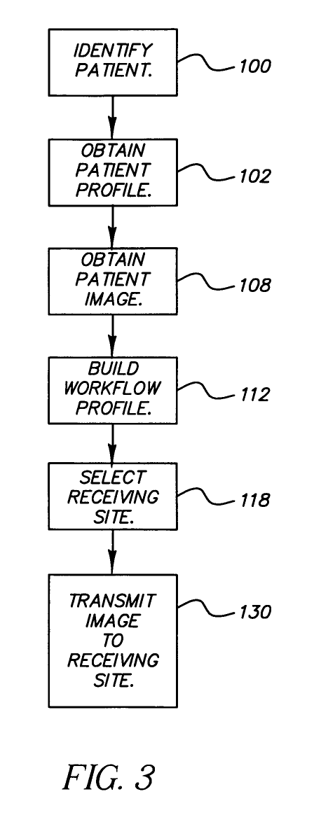

As the above description indicates, using diagnostic imaging apparatus 10, patient image and related diagnostic data, although typically stored at server 18 and provided from that facility, can be routed to various reading appliances 18 or to logic processors 34, 36, 40 in any number of ways. To determine the routing instructions for data from each patient 12, control logic from central services processor 28 applies requirements specific to that patient 12. This rule-based image transmittal, processing, and access control is a key to the overall flexibility of diagnostic imaging apparatus 10. Referring to FIG. 3, there is shown a block diagram that illustrates the rule-based image management of the present invention, from the perspective of image capture appliance 14.

The first step in processing the patient medical image or other data is an identification step 100 for identifying the specific patient 12 to diagnostic imaging apparatus 10. For example, prior to obtaining the patient images at the office of PCP 46, a keypad could be used for operator entry, or patient self-entry, of a social security number or other individualized identifier. Or, a scanning device associated with image capture appliance 14 could be used to identify a patient. Retinal scanning itself, since it has the capability for positive identification of a subject, could even be employed for identifying a continuing patient 12. Alternately, other identification methods using biometrics, such as scanning fingerprints or DNA analysis could be used. Next, in a patient profiling step 102 a patient profile is obtained. This patient profile gives general information about patient 12 that is needed to obtain additional information and may be obtained from a logic processor (not shown in FIG. 1) at the PCP office, or from a logic processor anywhere on network 16. The patient profile provides basic identifying information and various data fields giving date of birth, sex, address, employer, and contact information. The patient profile may also include various items of medical history data, continuing medications, family history, last known insurance carrier, etc. In one embodiment, the patient profile is stored in a database accessed and maintained by central services processor 28. In another embodiment, the patient profile is stored on a processor at the PCP site itself.

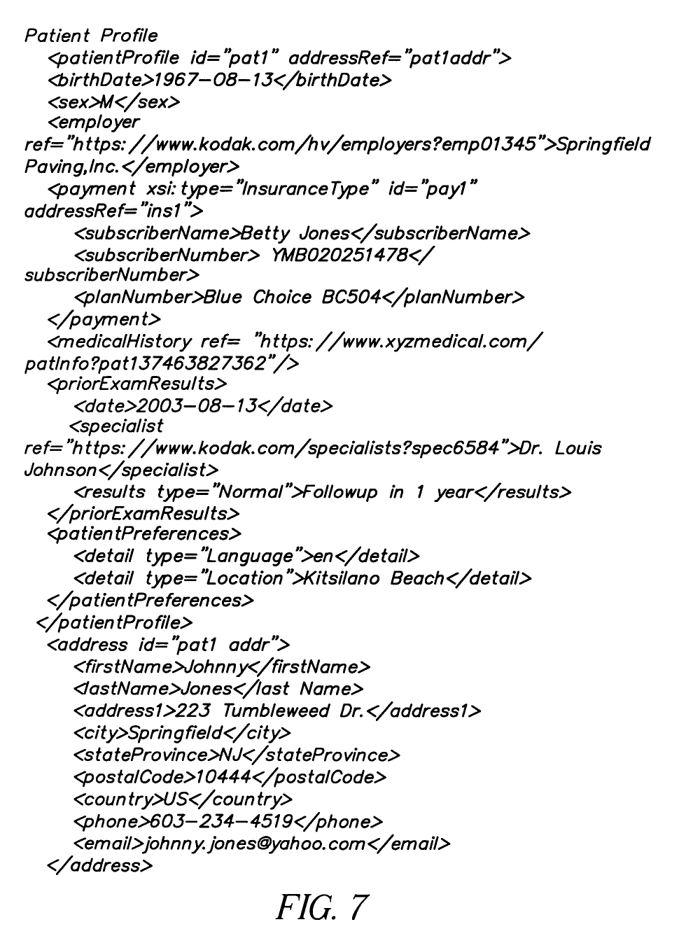

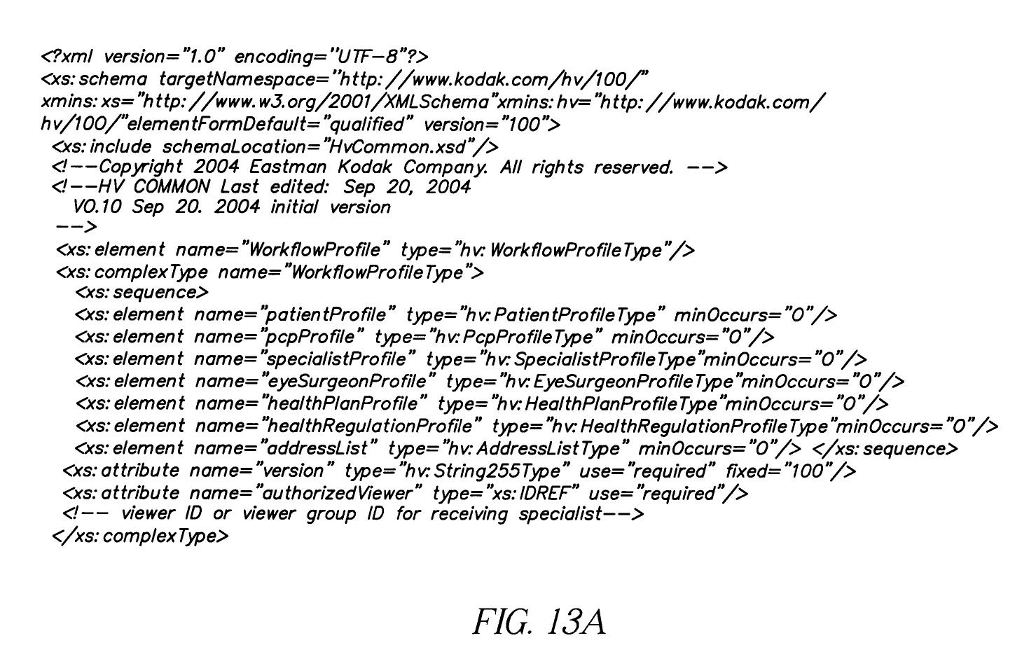

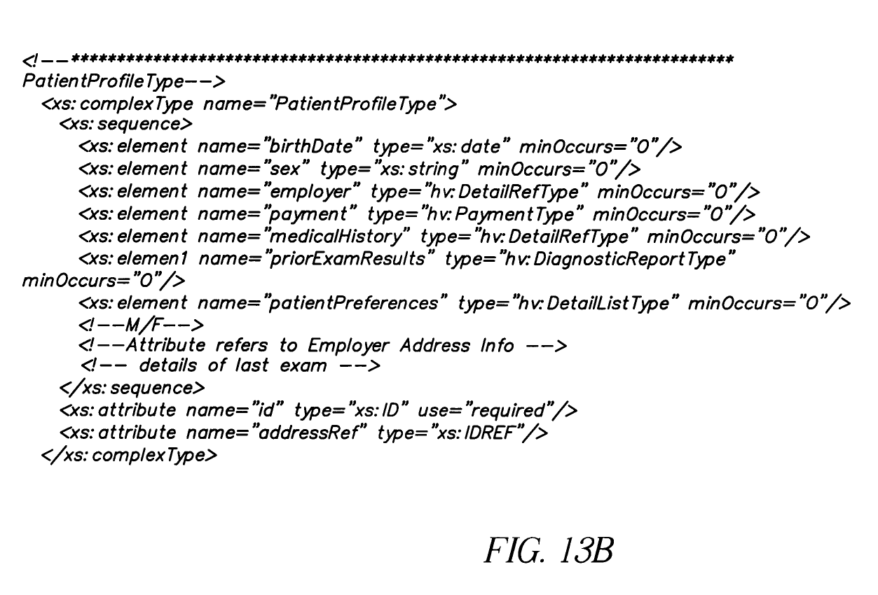

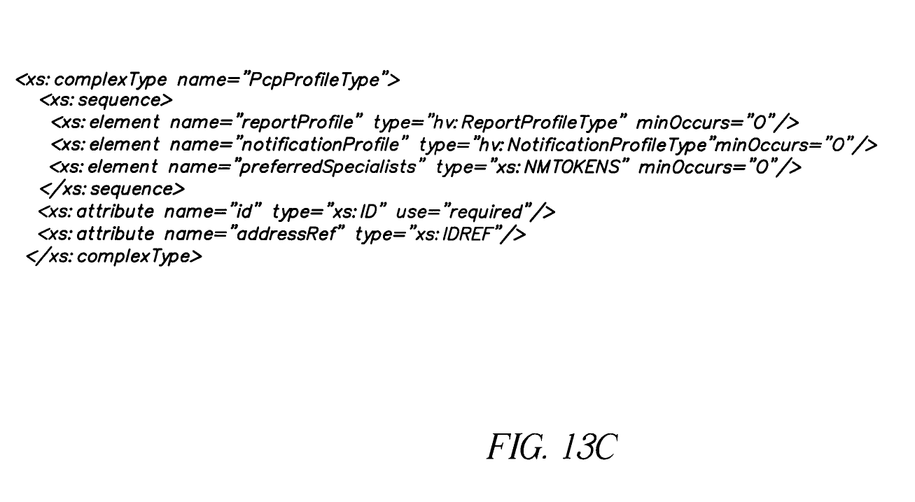

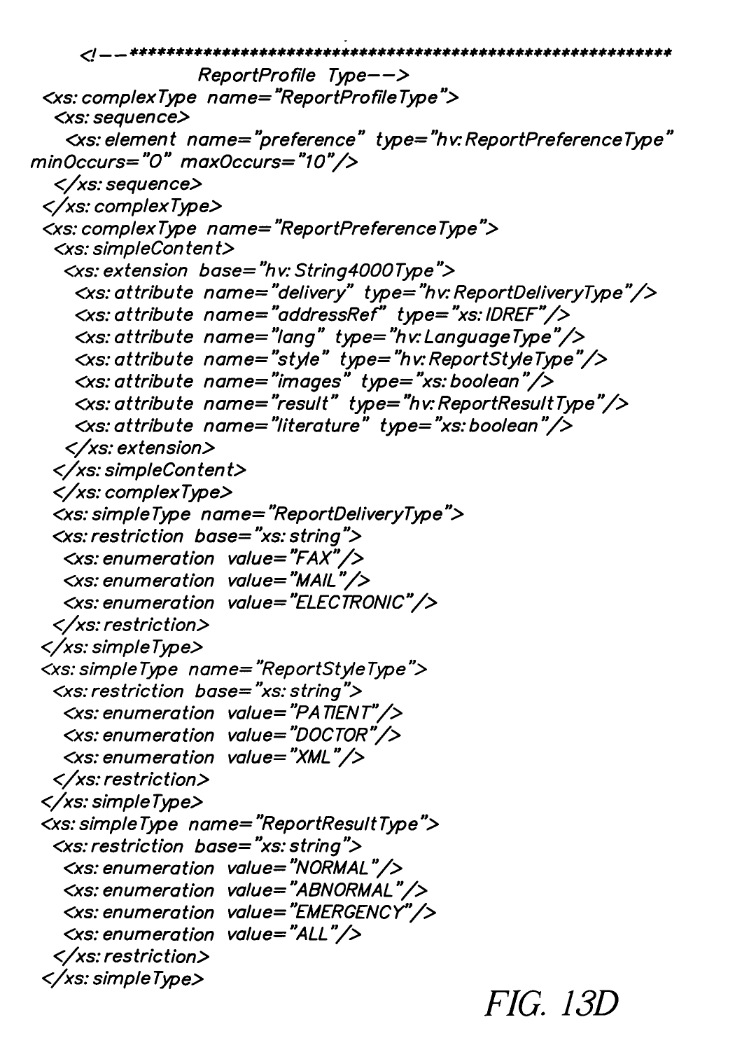

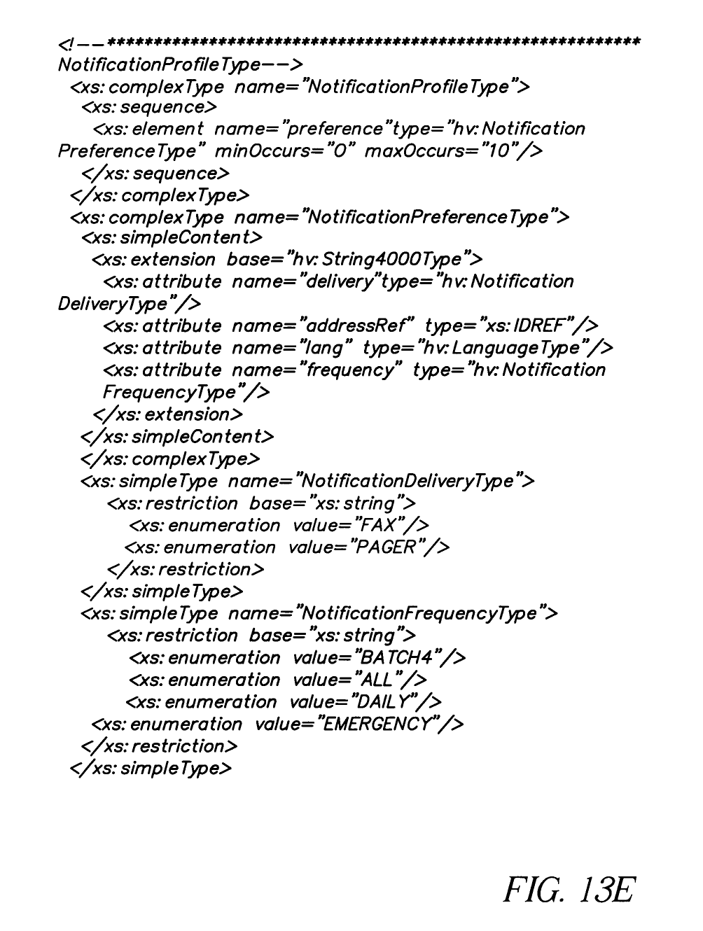

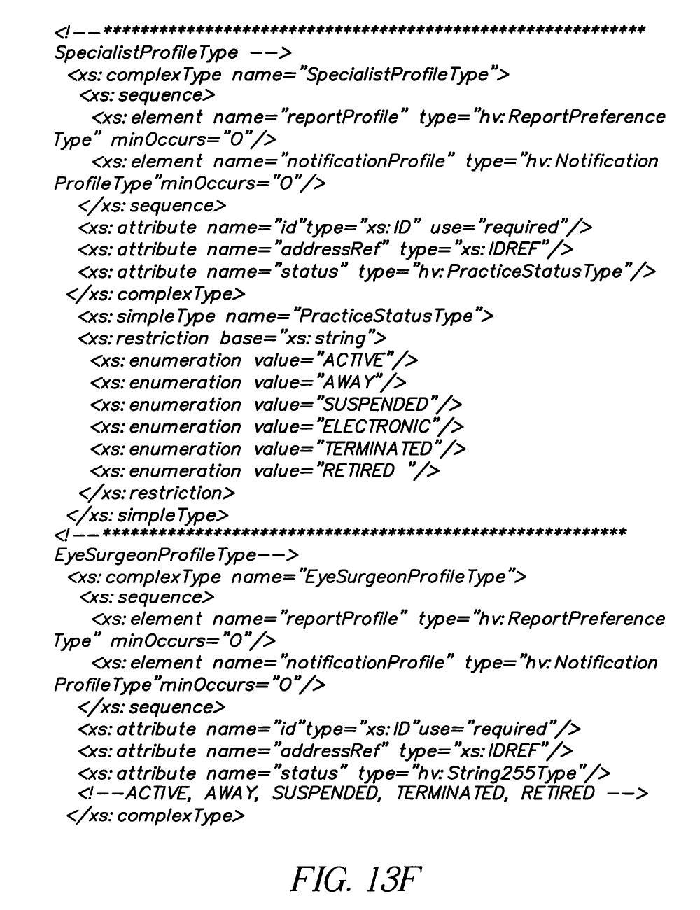

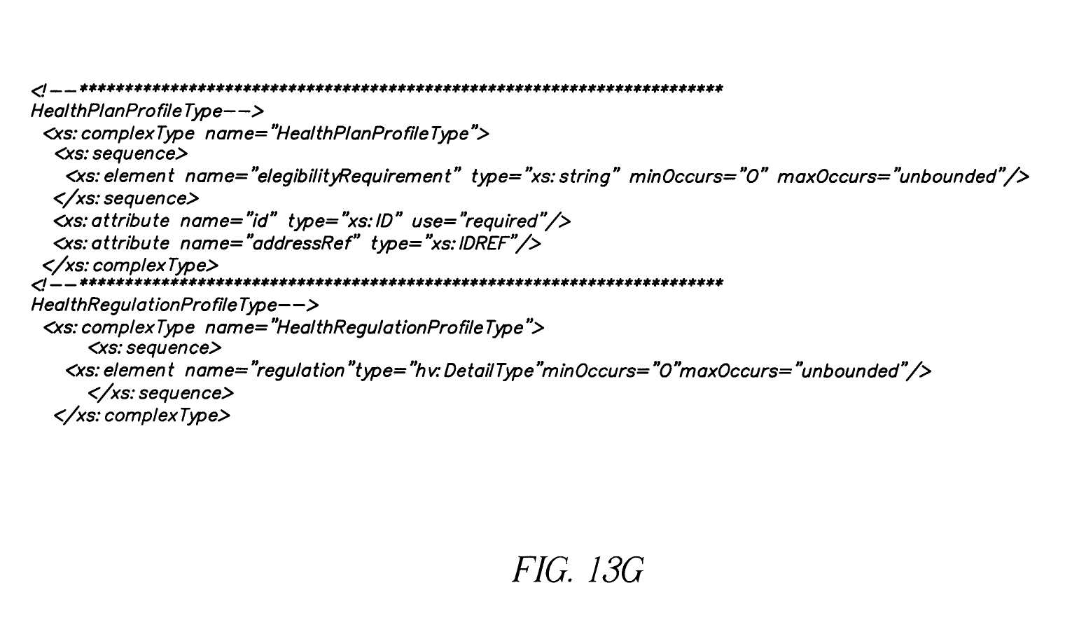

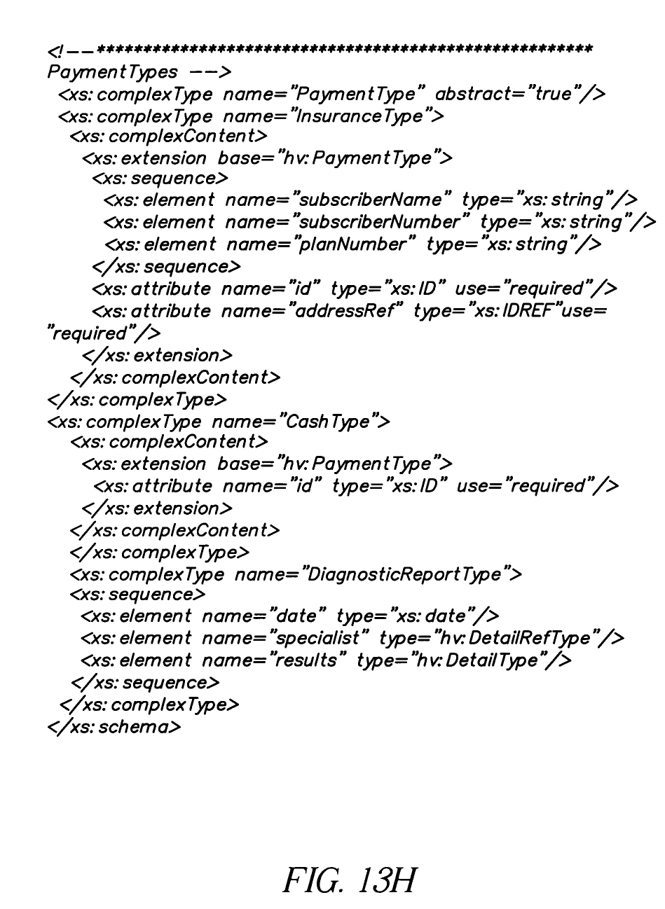

In diagnostic imaging system 10 of the present invention, the patient profile is a collection of patient metadata, that is, data about the patient, that includes data fields that may influence the routing of patient medical images. For example, various factual or preferential data may be weighted as factors in generating routing instructions. Referring to FIG. 7, there is shown an example data arrangement for a patient profile, showing a sampling of data fields that may be appropriate. FIG. 13B shows a portion of an XML schema corresponding to the example shown in FIG. 7. Among data fields provided in a patient profile are one or more notification profiles, that is, collections of data item(s) that give preference information for notifying the patient about testing and about test results under various conditions.

It must be emphasized that the fields shown in FIG. 7 are exemplary only, for the sake of showing typical data fields that can be in the patient profile, including data fields that may influence the routing of patient diagnostic data. Any arrangement of suitable fields for providing the necessary information on the patient can be used within the patient profile, encoded as a data structure in some form, such as in the XML encoding shown in FIG. 13B. As this example illustrates, specific fields such as Language, preferred specialist Location, or special needs information may indicate factors to be taken into account when assigning a specialist to view and assess medical image data about a specific patient.

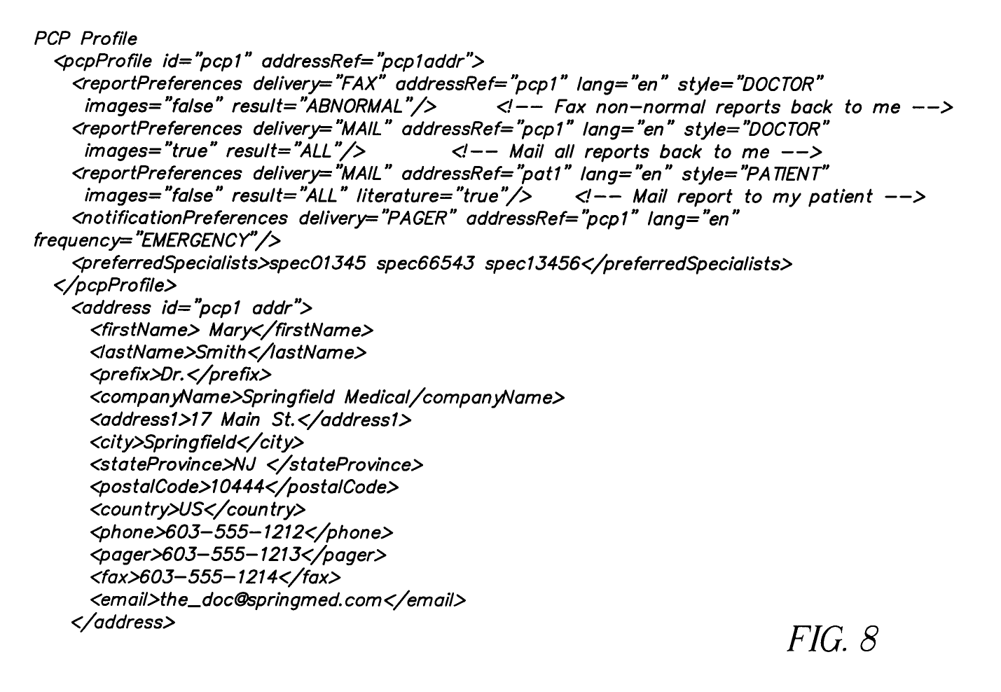

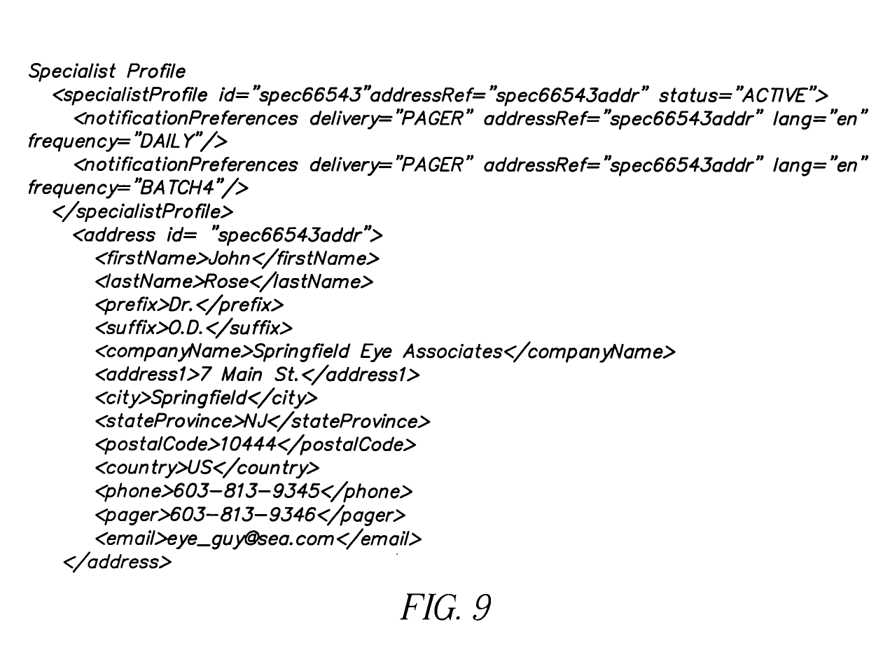

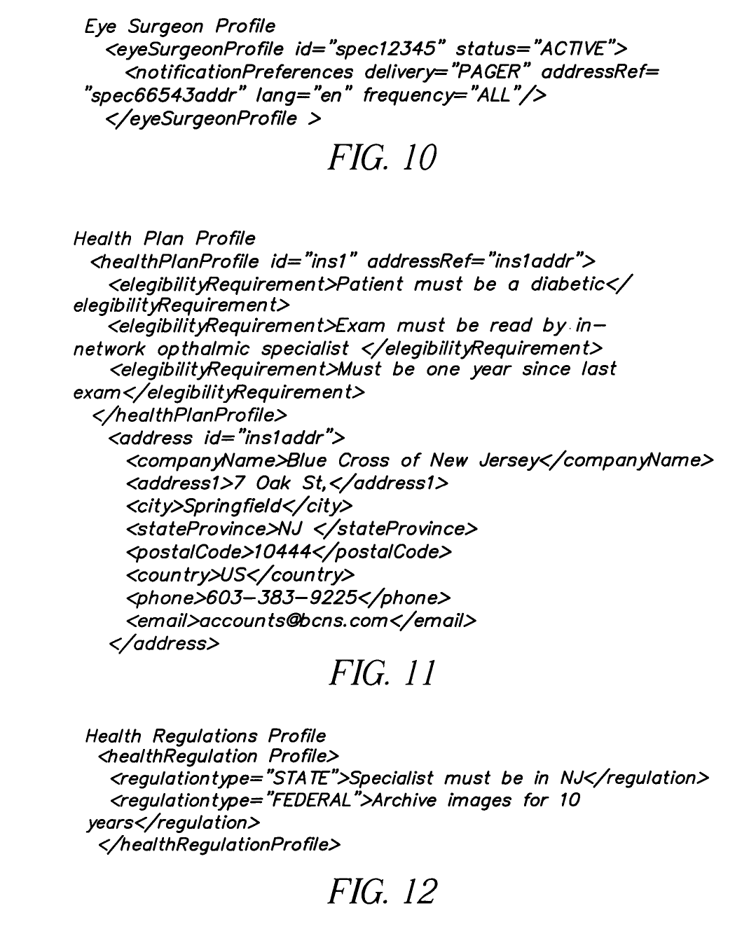

Again referring to the process flow diagram of FIG. 3, once patient 12 is identified and the patient profile provided, the medical image or other data can be obtained in an image capture step 108. For retinal imaging, for example, one or more diagnostic retinal images are obtained at image capture appliance 14. Image processor 30 in image capture appliance 14 (FIG. 2) performs any initial image processing functions that are required. Next, a workflow profile forming step 112 is executed, for forming a workflow profile that contains data from the patient profile and one or more additional profiles, such as the following:
(i) a PCP profile containing data about the primary care physician, as shown in the example of FIG. 8 and in the schema encoding of FIG. 13C;
(ii) a specialist profile containing data about a medical specialist or treatment facility, as shown in the example of FIG. 9 and in the schema encoding of FIG. 13D;
(iii) an eye surgeon profile containing data about a medical specialist, as shown in the example of FIG. 10 and in the schema encoding of FIG. 13F;
(iv) a health plan profile containing medical insurance coverage data about a patient, as shown in the example of FIG. 11 and in the schema encoding of FIG. 13G; and,
(iv) a regulatory profile containing health regulations data for a patient, as shown in the example of FIG. 12 and in the schema encoding of FIG. 13G;
(v) payment type information, as shown in the schema encoding of FIG. 13H; and
(vi) preferred notification data, as shown in the schema encoding of FIG. 13E.

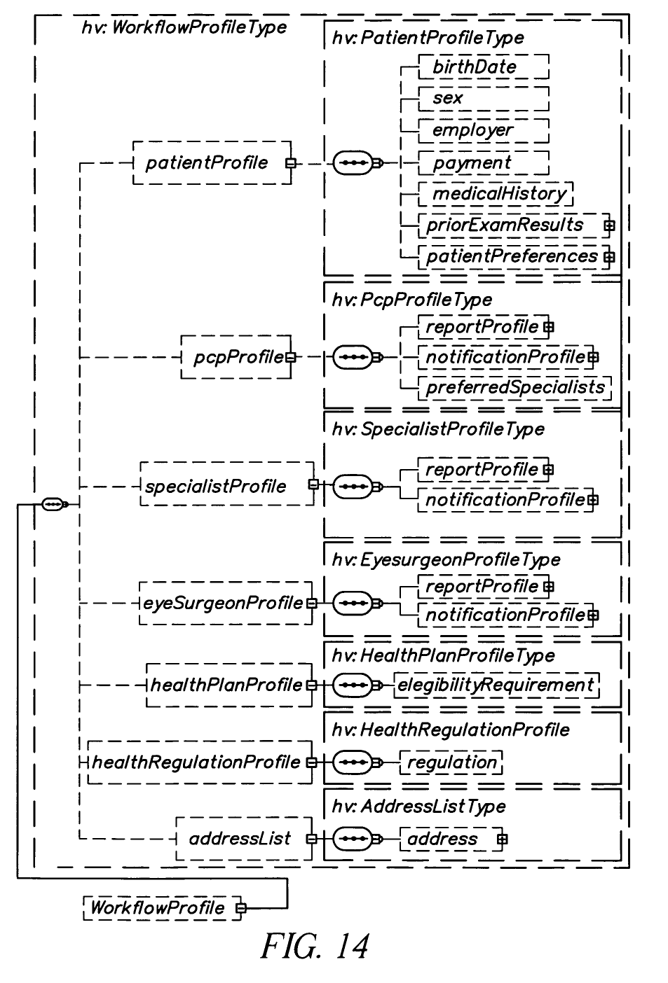

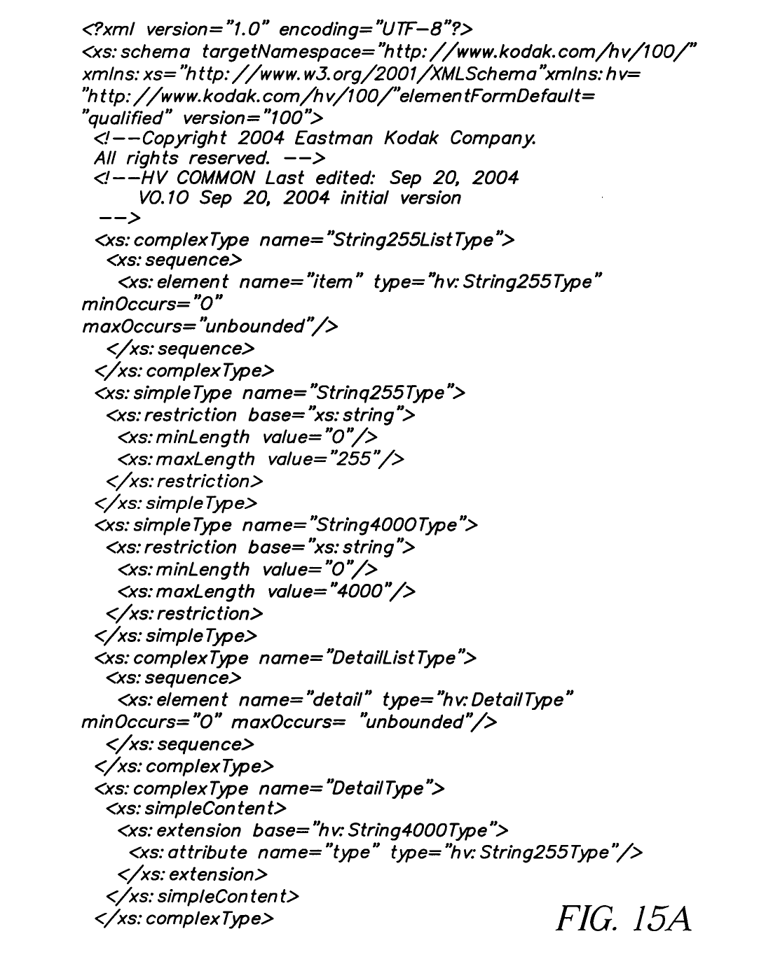

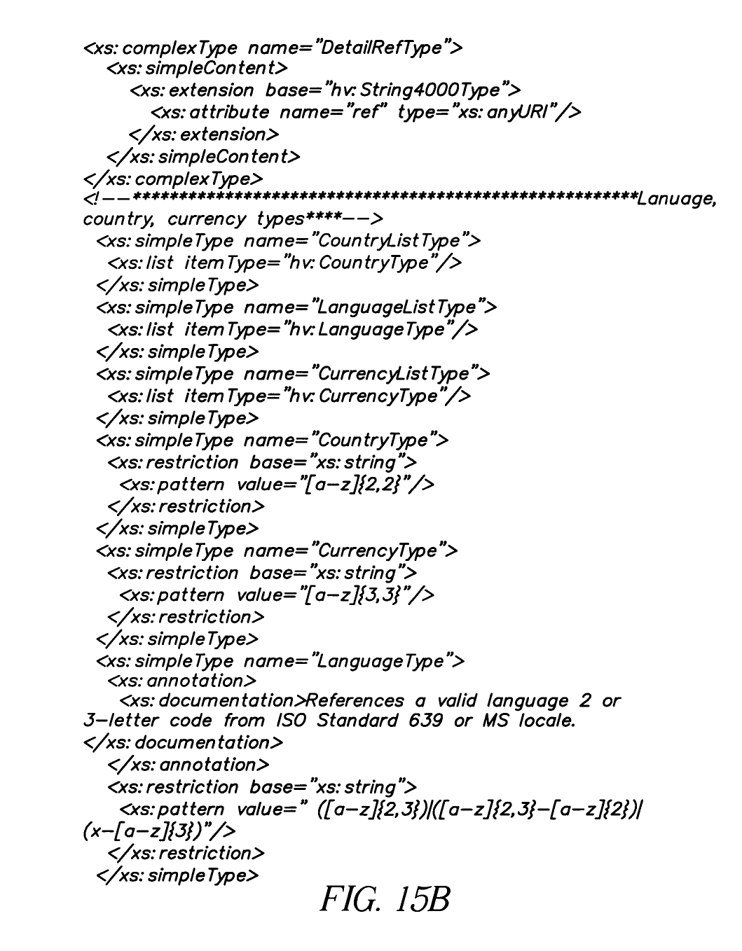

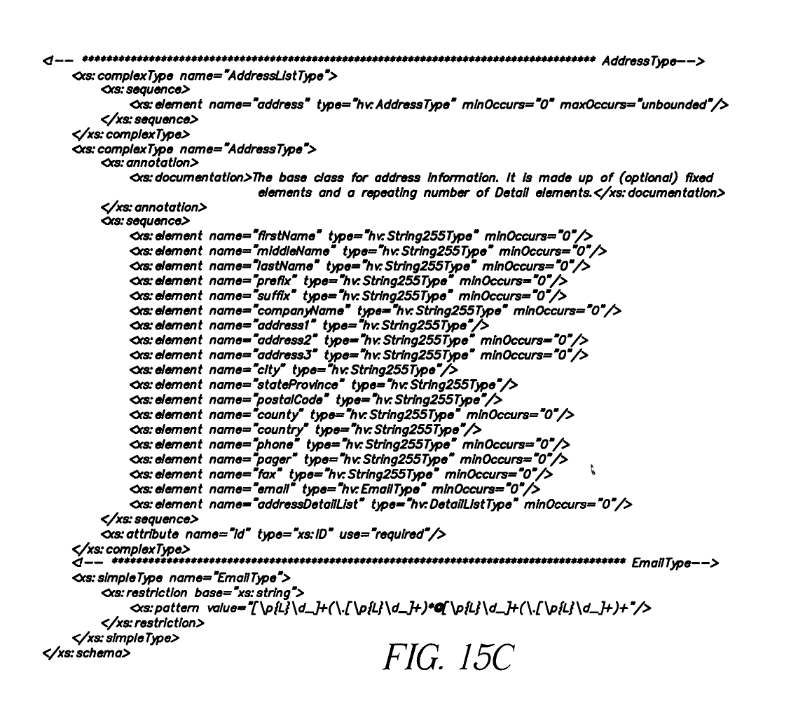

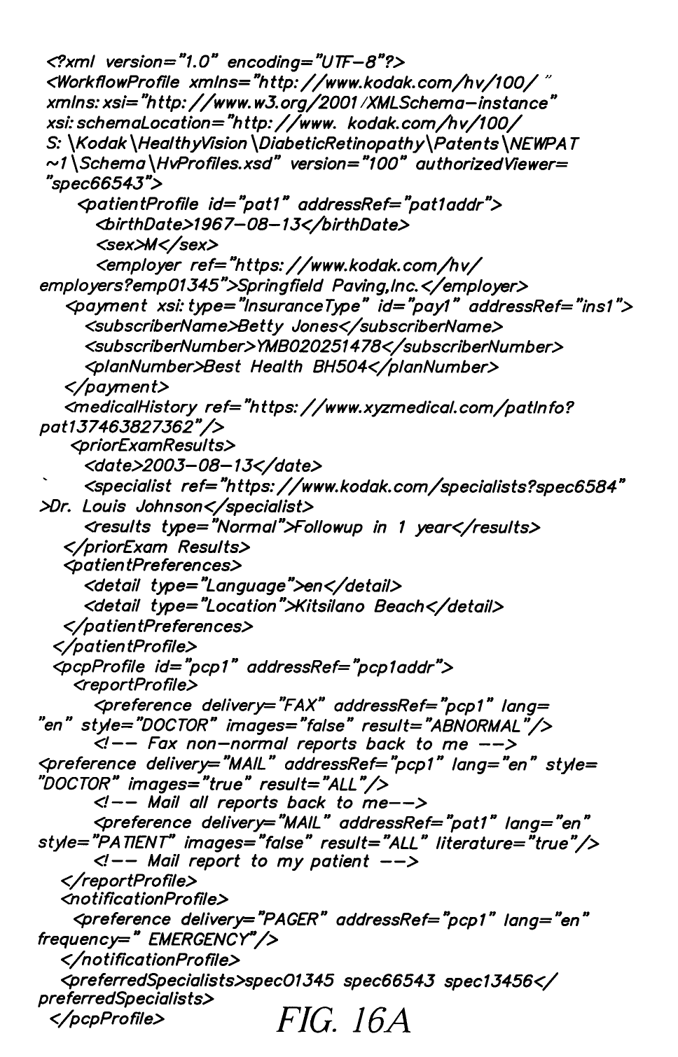

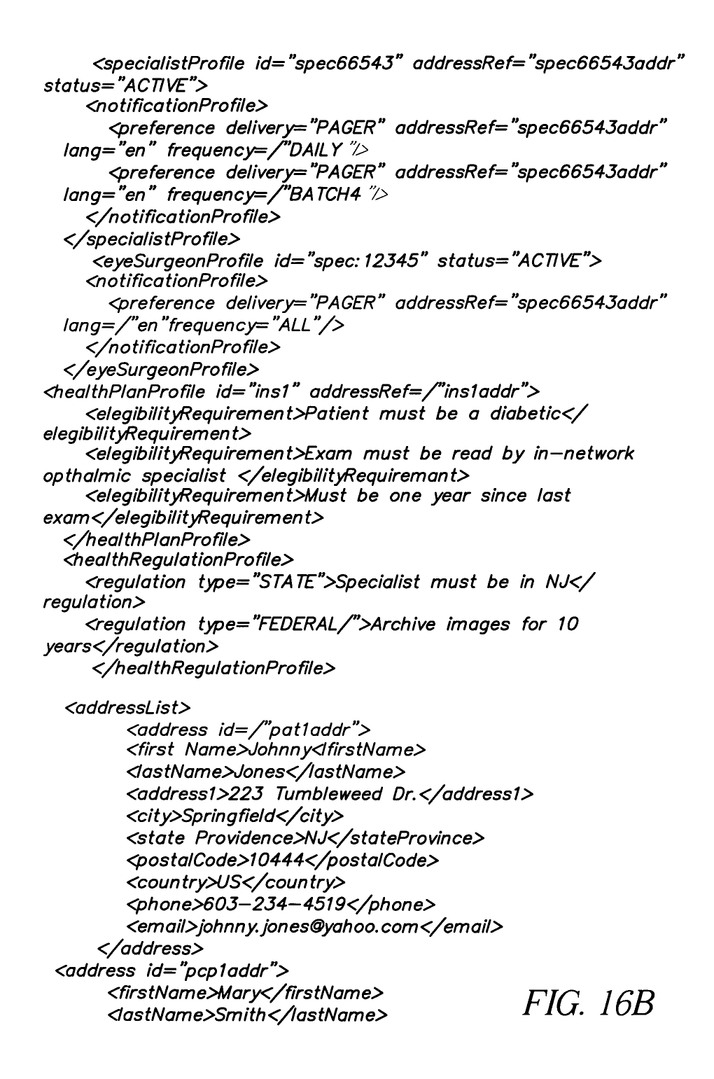

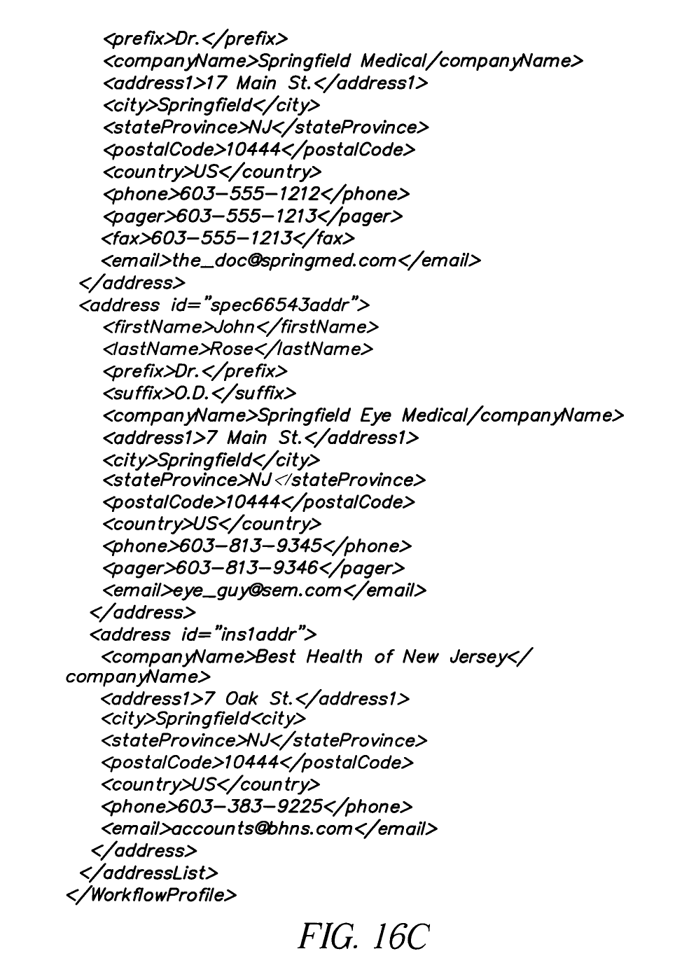

FIG. 14 shows a graphical representation of a typical workflow profile, according to the XML schema examples provided in FIGS. 13A-13H. FIGS. 15A, 15B, and 15C show example definitions for data structures common to multiple profile types. FIGS. 16A, 16B, and 16C show an example of a workflow profile generated using this overall arrangement.

It must be emphasized that the examples of FIGS. 7-16C are for illustrative purposes only and are not to be considered as limiting. For the method of the present invention, some type of patient profile data must be obtained, along with auxiliary data related to the type of medical data obtained from the patient. This auxiliary data must be obtained from some other networked site, such as a site that contains information about medical specialists, health care coverage, or regulatory requirements, for example.

After the workflow profile is formed, it can be processed in a receiving site selection step 118 to obtain a listing of suitable alternative receiving sites for the medical image obtained in image capture step 108 or other data obtained in an equivalent medical test. Then, based on data in the workflow profile, a suitable receiving site can be selected. The patient data can be transmitted to the appropriate receiving site in a transmittal step 130. In addition, the patient data can also be stored at one or more additional networked sites.

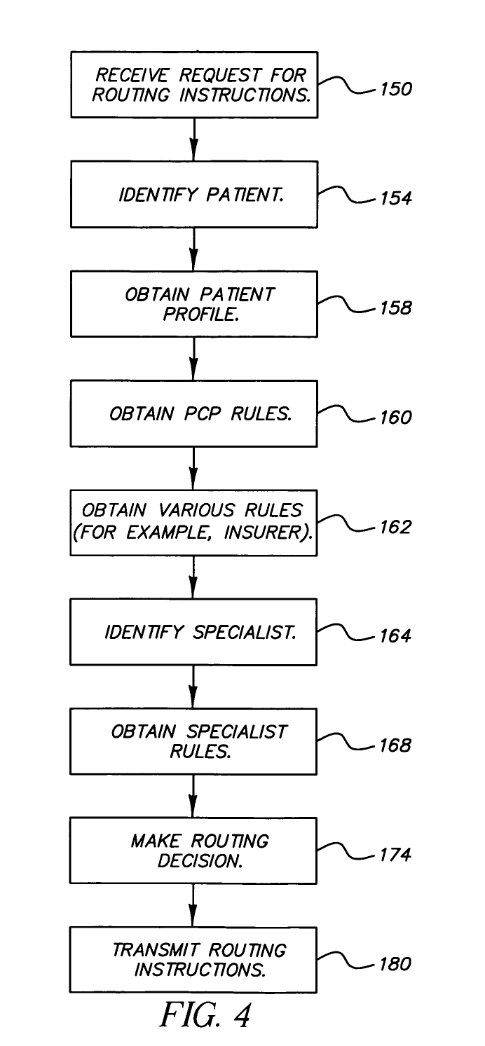

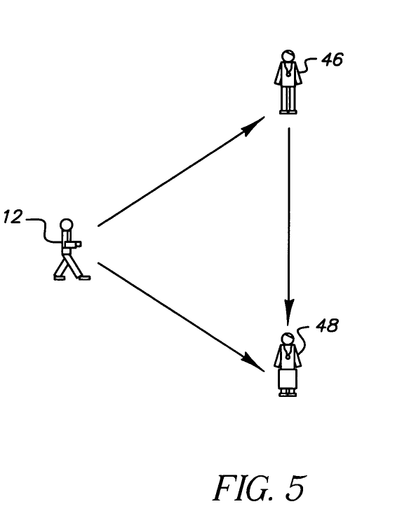

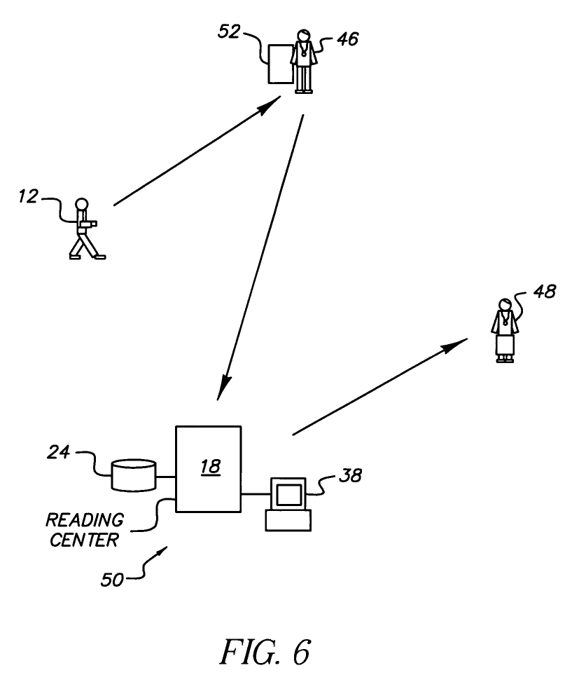

As was described above with reference to FIG. 3, image capture appliance 14 requests routing instructions for patient diagnostic data, where the routing workflow instructions may be formed as a type of data structure. In one embodiment, a request for routing workflow instructions goes to central services processor 28 for generating a workflow profile, with its embedded instructions. Referring to FIG. 4, there is shown the basic sequence for servicing the request generated when such a request is made. In a request receiving step 150, central services processor 28 accepts and validates the request for routing workflow instructions from the specific image capture appliance 14. Following this, a patient identification step 154 is executed, in order to query suitable databases for information needed about patient 12, in order to form a patient profile. Using data gathered about patient 12, a patient profiling step 158 is performed, in which data about patient 12 that is relevant to generating the necessary routing instructions is collected as the patient profile. This may include information sent along with the request from the PCP office or other test site, plus additional information obtained from any of a number of other databases accessible from network 16.

During the next sequence of steps, various rules and requirements are obtained from key participants in the diagnostic and authorization and reimbursement process. In an obtain PCP rules step 160, specific requirements laid down by PCP 46 are obtained. These requirements may specify, for example, preferred specialists or business arrangements, such as agreements with third-party services or with specific reading centers 50. In an obtain various rules step 162, central services processor 28, based in part on PCP rules obtained in obtain PCP rules step 160 and on the patient profile obtained in patient profiling step 154, gathers rules and requirements for transmittal of the diagnostic or other test data from patient 12 from various other sites on the network. For example, obtain various rules step 162 may obtain rules or preferences for routing image data from the following:
(i) insurance carrier(s). Insurance carriers may stipulate that medical images or data be sent to a specialist 48 and not to a reading center 50 or similar service. Conversely, an insurance carrier may want patient data sent to reading center 50 first for an initial screening. This may affect reimbursement and various referral conditions.
(ii) employer(s). There may be additional requirements made by employers for coverage, such as group coverage, under various health plans administered by or for a specific employer.
(iii) government rules.
(iv) business models.

Based on the patient profile, as was described above, and on rules and preferences obtained in obtain, typically as profiles, in PCP rules step 160 and obtain various rules step 162, central services processor 28 may perform an optional identify specialist step 164. In this step, a suitable specialist is identified, either for referral following diagnostic results obtained at reading center 50 or for receiving the images and other data directly. Following this, an obtain specialist rules step 168 may then be executed, to download rules information from logic processor 36 at specialist 48 site (FIG. 1). Specialist rules, typically included in a data structure such as a specialist profile, may indicate availability for accepting new patients, scheduling details, or recommended backup specialists 48 in the event that a specific specialist 48 will be unavailable. Or, assessed condition of patient 12 may influence referral to specific medical specialists 48 who treat various conditions.

After gathering all of the needed information from various sites along network 16, typically stored as profiles that can be maintained and independently updated by separate systems at each site, central services processor 28 is able to process and generate a routing instruction. Acting as an inference engine, central services processor 28, working with a workflow profile, carries out a make routing decision step 174. In this step, central services processor 28 evaluates the various rules and preferences from PCP 46, patient 12, specialist 48, insurance carrier(s), employer(s), including business arrangements, local and federal government guidelines and other criteria, obtained from the various profiles described. Central services processor 28 then provides a routing instruction, typically as a workflow profile, to image capture appliance 14 for sending the image and/or related diagnostic data from the PCP office or other test site at which the data were obtained.

Once routing instructions for patient 12 data are obtained in this way, transmit routing instructions step 180 is executed by central services processor 28, sending the routing instructions to image capture appliance 14 at the PCP site. Image capture appliance 14 then transmits the obtained images to one or more other systems on network 16 accordingly. Typically, patient images will be transmitted to server 18, even where image data was also sent to some other party on network 16. Images are transmitted to server 18 for storage and for making images accessible as needed by various reading appliances 20, 22, 26 on network 16. In addition to routing the image data, transmit routing instructions step 180-may also execute the supporting step of providing other sites with additional background information or medical history for the patient.

Role of the Specialist

One important aspect of diagnostic imaging system 10 of the present invention relates to interaction with specialists 48. Considerable flexibility is provided to adapt to specialist preferences and requirements in image acquisition, routing, and assessment, encouraging specialist participation in the workflow scheme of the present invention. As noted earlier, some specialists 48 have expressed reluctance, at least initially, in accepting the diagnosis of reading center 50 personnel. Or, specialist 48 may want only a specific level of assessment from remote reading center 50. This may vary with patients 12 and their conditions and can change over time. By developing a unique routing instruction for each set of patient images, the system and method of the present invention allow specialist 48 the flexibility to interact with reading centers 50 and PCP sites in a preferred way.

In the conventional model employed in the commercial systems currently in use, the centralized reading center automatically obtains all images from PCP or other testing sites. The reading center than performs initial screening and provides test results back to the PCP for referral. The specialist has little or no involvement in this initial screening process. In contrast, diagnostic imaging system 10 of the present invention allows a number of different schemes for medical image routing and initial assessment. A particular specialist 48 may be satisfied with the assessment of reading center 50, particularly for non-critical cases, and may not choose to view images for patients 12 unless conditions of a certain threshold level are detected. Alternately, specialist 48 may want the capability to access to any and all patient images, regardless of reading center 50 determinations. Specialist 48 preferences as to image viewing would be applied to routing instructions for patients 12 whose cases are referred to that practitioner.

Image Quality Feedback

Diagnostic imaging system 10 provides an image quality feedback mechanism that enables images of suitable image quality to be obtained from image capture appliance 14. Each image obtained for patient 12 can be immediately transmitted to reading center 50, where some combination of assessment by trained personnel as well as automated image assessment tools can help determine whether or not image quality is acceptable for screening purposes. This helps to prevent the need for recalling patient 12 in the event of operator error or incorrect adjustment of imaging components in image capture appliance 14. Feedback can be provided immediately upon receipt of the patient image or other data. This feedback could relate to the quality of the data or could related to diagnostic assessment of the data itself. For example, a technician at a reading appliance 22 could be assigned the function of reporting back on the overall image quality of a retinal scan. Or, a certified specialist may be assigned to provide a diagnostic assessment and report this information back immediately. This real-time, on-line reporting of diagnostic results is advantaged over conventional systems, that may provide image quality assessment such as using diagnostic software to report back to the PCP site.

How Rules for Participant Interaction Determined

As shown in the flow diagram of FIG. 4, and in the data structure examples of FIGS. 7-16C, central services processor 28 obtains various rules, preferences, and other data that influence its development of routing instructions for a set of patient images or other diagnostic data. Particular steps in which this information is obtained include patient profiling step 158, obtain PCP rules step 160, obtain various rules 162, and obtain specialist rules step 168, for example. In each of these steps, some type of information is obtained, typically as data profiles, from each of multiple participants in the image distribution and access scheme. In order to provide this information from each of these multiple sites in some usable form so that a decision can be made, numerous software utilities are employed. For example, for obtain specialist rules step 168, a specialist profile must be developed and updated regularly. In order to do this, a software program queries a scheduler program used by the particular specialist 48. In this way, the availability of specialist 48 for consultation or image assessment can be quickly determined. Obtaining other types of information about specialist 48 can be somewhat more difficult. For example, the tasks of determining whether or not a particular specialist 48 practices in a particular area of pathology, or determining at what threshold condition specialist 48 wishes to have image files transmitted directly to a local logic processor 36 for viewing, or determining which alternate specialist 48 may be commissioned to handle cases in the event that a particular specialist 48 is unavailable may not be easily accomplished by querying conventional medical specialist scheduling software. In one embodiment, a specialist preferences software utility is provided to specialist 48 for use in transactions with diagnostic imaging system 10, so that a specialist profile can be formed. In order to participate in the image downloading and viewing capabilities of diagnostic imaging system 10, specialist 48 then generates, maintains, and updates usable data for satisfying the requirements of central services processor 28 when executing obtain specialist rules step 168.

In obtain various rules step 162, central services processor 28 queries insurance carrier(s), employer(s) and other relevant parties for routing preferences information. For example, an employer may specify that certain types of tests are or are not covered for a level of reimbursement under an employer plan, such as for a certain classification of salaried employees. This may override, supercede, or supplement restrictions or guidelines posited by the insurance carrier. It can be seen that preliminary to obtain various rules step 162, a number of software utilities must be employed at sites of these various participants in diagnostic imaging system 10. In one embodiment, a software utility is provided to employers to determine special coverage conditions and to maintain a file profiling these conditions, where this file can be accessed and interpreted by central services processor 28.

For interaction with insurance carriers, central services processor 28 may maintain a feed directly from the insurance carrier database. This interface uses database access techniques well known to those skilled in the database software arts. This enables central services processor 28 to have up-to-the-moment coverage information on each patient 12, so that medical images and test data can be suitably routed based on coverage at the time the data are obtained. In one embodiment, a health plan profile is provided and constantly updated, as was shown in the example of FIG. 10.

It must be noted that, while central services processor 28 provides the data gathering and inference engine logic for obtaining rules and preferences from numerous sites around network 16 in the embodiment described with reference to FIG. 1, other embodiments are possible. For example, the logic control functions executed by central services processor 28 in the above description could be more broadly distributed to other logic control devices, such as logic processors 34, 36, 38, or 40. In yet another embodiment, control logic running on image capture appliance 14 could generate routing instructions based on information obtained from other sites. In this alternate embodiment, a Java-encoded software program running on image capture appliance 14 successively obtains the necessary information about patient 12 and PCP 46, then queries one or more insurance carrier sites, an employer site, and one or more specialist sites in order to make a routing decision. Using an interpreted Java-based program has advantages, since the resident software at any of a number of PCP sites can be regularly updated, along with some of the relevant data needed for making routing decisions. In still another embodiment, a daily or weekly update is generated for a listing of all covered patients 12, maintained at some central site or server or parceled out appropriately to PCP offices for their assigned patients 12. This arrangement would have some advantages for providing predetermined routing instructions that would be readily available and continually updated.

One key consideration for providing routing instructions is to maintain updated information. Outdated information about any of the participating partners to diagnostic imaging system 10 could cause the generation of routing instructions that are not correct. For example, a particular specialist 48 may go on extended vacation, visiting professorship, maternity leave, sabbatical, or move to another practice. Similarly, continuing changes in insurance provider provisions, in local and federal governmental requirements, and in employment status could easily render stored information obsolete unless a continuing update effort is maintained. Thus, regardless of where the routing instruction is generated, each participant in diagnostic imaging system 10 must regularly update information provided for preferences and rules.

The use of profiles, as described and shown in the examples of FIGS. 7-16C provides structures having a straightforward format, where the data structures can be readily updated, independently of each other, without impacting system performance. In another embodiment, the image data, or other diagnostic data, is transmitted directly to other participant sites, in addition to being transmitted to server 18 for storage or archival. With this arrangement, one or more of logic processors 34, 36, 38, 40 handle receiving and storing the image and/or test data for subsequent viewing, manipulation, and diagnostic assessment. The participating specialist 48, insurance carrier, or other party is then notified that the information has been downloaded, such as by email, fax, etc. In an alternate embodiment, the images and/or test data are initially sent only to server 18 for storage. Authorized participants for viewing, using, and storing the data at other sites are informed, by email or other method, of the availability of this diagnostic data. Then, when ready to access and use the diagnostic data, participants from these other sites can log in to server 18 and download the data needed.

In one embodiment, all of the image data obtained is available to any authorized participant who uses diagnostic imaging system 10. However, this may not be necessary or desirable with some types of data. For example, an insurance carrier may not want transmission of several megabytes of image data to logic processor 40. Instead, all the information the insurance carrier may need can be packaged in a small text file, giving patient identification, date of the test performed, image routing information, specialist recommendations or preferences, employer data, and other suitable information. This minimal amount of data may be all that is needed in order for the insurance carrier to initiate reimbursement processing.

With further reference to the sequence of steps shown in FIG. 4, it can be readily appreciated that the steps shown for this embodiment are exemplary and may be modified and/or rearranged within the scope of the present invention. For example, the specialist determination obtained from identify specialist step 164 could be deferred until a decision is reached based on coverage information from an insurance carrier or employer. In another embodiment, all routing instructions for patients 12 covered under a particular insurance carrier plan may simply be the same, without reference to other participants in diagnostic imaging system 10. However, the built-in flexibility of diagnostic imaging system 10 would still be usable for patients 12 under other coverage plans or for future use.

In one embodiment, the routing instruction is an IP address; in another embodiment, a separate file is appended to the patient's data, listing suitable network addresses for transmittal of image data and for results transmittal.

### EXAMPLE

As an example using the method of the present invention, during the routine visit by a patient to a first site, which may be primary care practice office, a retinal image is acquired. The system prompts for the patient's identification from the image acquisition operator, or automatically requests it from a medical practice management system. This identification is used by the system to access the patient profile. Since the patient is covered by an insurance company, the system proceeds to access the insurance company's profile to determine which health plan is applicable to the patient based on the patient's employer id and plan option. From the applicable healthcare plan the system extracts the plan's eligibility requirements for the exam. For example, an exam may be covered once a year provided the images are read by an approved ophthalmic specialist. The patient profile is checked to verify that the patient's previous exam was more than a year ago.

The system next extracts the list of eligible eye specialists from insurance company profile. The system uses the ID of the eye specialist who had written the previous report from the patient profile and extracts the profile from of this eye specialist and also extracts the list of preferred eye specialist from the PCP's profile. In this example, the system detects from the specialist's profile that the eye specialist has retired, and proceeds to compute a common list from the insurance company's eligible list and the PCP preferred list. This common list is now validated against the preferences of the patient specified in the patient profile. Assuming that the patient prefers an English-speaking specialist, the system shortens the list accordingly. Assuming that the short list has only one candidate, the system proposes this name to the operator and the patient for their final approval. Assuming for our example that the proposed specialist is acceptable the system begins the task of preparing the final workflow profile (as shown in the process of FIG. 3) and medical data.

If an electronic patient record is available, the system can access it for additional clinical information such as glucose level, weight gain etc to assemble the information that is necessary, in addition to the medical images, for the specialist/technician to perform the diagnostic screening for the diabetic retinopathy. Otherwise the system prompts for the operator to input the necessary clinical information.

The system then accesses the profile of the selected eye specialist at the second site. First, the profile is checked to assure that the specialist is available for the diagnosis. Next, the notification preferences of the eye specialist are checked to see how and when to notify the second site once the medical data is transmitted to the second site. The second site may specify, for example, that notification be initiated via pager message whenever four or more screening tests are pending, or at the end of the day. The system accesses the wait queue for the second site and, assuming that there are three tests in the queue, concludes that the new test will reach the specified threshold for notification. The system then proceeds to send medical data to the second site and sends a pager message that includes the total diagnostic screening tests in the wait queue for the specialist at the second site.

In a slightly different example, during the routine visit by a patient to a first site, which may be primary care practice office, a retinal image is acquired. The system prompts for the patient identification from the image acquisition operator or automatically requests it from the medical practice management system. Patient identification is used by the system to access patient profile. The system extracts the ID of the eye specialist who has written the previous report from the patient profile. The system uses the specialist's id to access the specialist's profile to test specialist availability. Assuming for this example that the specialist is away on vacation, the system will then extract the backup specialist's ID specified by the original specialist profile, as well as any backup reporting requirements. The system next accesses the profile of the backup specialist to extract the address of the second site and the reporting and notification specification in a similar manner described in the first example above.

The system also accesses the PCP profile, which contains preferences for how and when to notify the PCP office of the availability of the report from the specialist. For example, the PCP may specify that a plain English version of the diagnostic report be mailed to the patient that includes educational literature under the PCP's letterhead with a copy to the PCP. In addition, if the diagnostic report is not normal, the PCP may wish to be notified by pager of the abnormal exam, to be followed up by a report by fax. This information is included in the final version of the workflow profile.

As described in the first example, the system assembles the medical data and sends it to the second location, and then notifies the second site. Upon receipt of the notification, the specialist accesses the pending medical data, performs the diagnosis, and inputs the report and the level of disease progress. Assume for this example that the diagnosis is not normal, but that the patient need not see an eye specialist immediately. The system detects this diagnosis and accesses the workflow profile associated with the original medical data. It extracts the reporting and notification requirements for this workflow profile. In particular, it obtains information on how to form the diagnostic report and how to send it to the PCP. In this example, the system sends a copy of the report to the PCP via fax and sends a notification to the PCP via an e-mail message as specified. In this example, the system requests a third site to convert the original report into plain English language, add specified literature and customize it under the letter head of the specified medical practice. This material is then mailed from the third site to the patient via regular mail. In addition, a report is sent to the original eye specialist on vacation in the form and factor that is specified in their profile for their records. This example assumes that the original specialist has specified that the kind report be send in the form of e-mail with a link to an secured site where the text of the report is stored.

Notification and Transmission of Diagnostic Assessment Results

Among advantages of diagnostic imaging system 10 are its flexibility in providing flexible and dynamic routing instructions that also encompass the transmission of diagnostic results. That is, the routing instructions generated by central services processor 28, or generated by some other logic control device or arrangement of devices on network 16, may also provide instructions for transmitting a diagnostic report giving results of an assessment of images or other test data. Thus, for example, following assessment by specialist 48, a diagnosis report, compiled by specialist 48 or qualified staff members, is transmitted to one or more participants according to routing instructions. Or, following assessment by reading center 50, a summary report may be generated and distributed according to routing instructions.

One aspect of results reporting relates to the types of information sent to other participants. The patient, for example, may require only a quick summary of the diagnosis in text form. An insurance carrier may need other information that is not of direct interest to patient 12 or to PCP 46, but is of interest for billing or for use in subsequent treatment considerations. An employer may not need or be permitted to have access to specific diagnostic information, but may need only to know that the test was performed and the diagnosis properly reported. In one embodiment, the initial routing instructions generated from central services processor 28 at the time the image or test data is obtained from patient 12 provide this information for obtaining feedback from diagnostic participants. In another embodiment, a separate set of routing instructions is generated by central services processor 28 following diagnostic assessment. In this embodiment, the diagnostic results themselves condition the routing instructions generated. Thus, for example, results from reading center 50 may be forwarded to specialist 48 directly where patient 12 exhibits a condition determined to require immediate attention. The format of the data can be varied, based on the intended recipient. For example, results forwarded to the patient may include a key subset of the data, with analysis expressed in layman's terms, whereas reports sent to a specialist may include the full set of data and more specialized terminology.

A notification profile can be included as part of the patient, PCP, or specialist profiles or can be generated as a separate data entity, with the overall schema arrangement shown in FIG. 13E, for example. The notification profile can include information on how a patient or specialist wishes to be notified of the availability of test data or of diagnostic results. This may also include information on the method preferred for notification. Alternately, the transmitting site may query the intended receiving site to determine the preferred method for notification and/or transmission of results and reports.

Coordination with Billing and Reimbursement Systems

One aspect of the present invention that can be particularly advantageous relates to its flexibility for dealing with variable billing and reimbursement schemes. Unlike the static image transmission and reporting characteristic of existing systems, diagnostic imaging system 10 of the present invention allows billing and reimbursement information to be available at any of several points in network 16, according to permitted access. Thus, for example, patient 12 may be informed of proposed reimbursement at the PCP office, before or immediately following testing. PCPs 46 and specialists 48 can obtain information relative to reimbursement and billing for current and referred patients 12, even including a preference for obtaining reimbursement information as part of results reporting. Payment on a per-test basis can be computed. A payment profile, as shown in the example of FIG. 13H, can be generated for maintaining reimbursement information for a specific diagnostic test.

While the apparatus and methods described above for the present invention primarily relate to medical images, it can be appreciated that much of the same arrangement of diagnostic imaging system 10 could be applied for obtaining other types of diagnostic test data for patient 12 and for determining how to route this data to participants around network 16. Other types of test data of interest could include blood sample results or information from tests of other body fluids, data from EKG apparatus, or sleep pattern data for example.

The invention has been described in detail with particular reference to certain preferred embodiments thereof, but it will be understood that variations and modifications can be effected within the scope of the invention as described above, and as noted in the appended claims, by a person of ordinary skill in the art without departing from the scope of the invention. For example, diagnostic imaging system 10 flexibly allows connection between any number of image capture appliances 14 and reading appliances 20, 22, 26, serving patients and medical professionals over a broad geographic area. A number of different arrangements for dynamic generation of routing instructions for diagnostic imaging data are possible, depending on the needs and requirements of various participants in providing and reimbursing diagnostic imaging services. A variety of notification methods may be used, including notification from a remote site.

As noted above, there is a compelling need for improvement in the delivery of medical treatment to patients, particularly those who have diabetic retinopathy, macular degeneration, and other debilitating conditions that affect vision. The apparatus and method of the present invention provide a flexible system for more efficiently and effectively providing remote screening of ophthalmic and other medical images.

### PARTS LIST

10 diagnostic imaging system
12 patient
14 image capture appliance
16 network
18 server
20 reading appliance
22 reading appliance
26 reading appliance
24 database
28 central services processor
30 image processor
32 routing control processor
34 logic processor
36 logic processor
38 logic processor
40 logic processor
46 primary care physician (PCP)
48 specialist
50 reading center
52 fundus camera apparatus
100 identification step
102 patient profiling step
108 image capture step
112 workflow profile forming step
118 receiving site selection step
130 transmittal step
150 request receiving step
154 patient identification step
158 patient profiling step
160 obtain PCP rules step
162 obtain various rules
164 identify specialist step
168 obtain specialist rules step
174 make routing decisions step
180 assignment step

1. A method for dynamically routing medical data related to a patient in a communications network, comprising:
(a) obtaining the medical data about the patient at a first site;
(b) obtaining patient profile data comprising information associated with the patient;
(c) processing the patient profile data and identifying a receiving specialist site based on the patient profile data; and
(d) transmitting the medical data to the receiving specialist site.

2. A method according to claim 1 wherein the step of obtaining the medical data comprises the step of capturing an image.

3. A method according to claim 1 wherein the step of obtaining patient profile data comprises the step of requesting data from a networked site.

4. A method according to claim 1 wherein the step of obtaining patient profile data comprises the step of identifying the patient by performing a retinal scan.

5. A method according to claim 1 wherein the step of identifying a receiving specialist site comprises the step of obtaining additional data from an insurance carrier site.

6. A method according to claim 1 further comprising the step of notifying the receiving specialist site about the availability of the medical data.

7. A method according to claim 1 wherein the step of identifying a receiving specialist site comprises the step of obtaining additional data from at least one of said plurality of available specialist sites.

8. A method according to claim 1 wherein the step of identifying a receiving specialist site comprises the step of obtaining additional data associated with a government regulation.

9. A method according to claim 1 further comprising the steps of assessing the medical data at the receiving specialist site and, based on the assessment, transmitting the medical data to a third site.

10. A method according to claim 1 wherein the step of transmitting the medical data comprises the step of using an internet connection.

11. A method for managing medical image data for a patient, comprising:
(a) obtaining the medical image data at a first networked site;
(b) obtaining patient profile data associated with the patient;
(c) transmitting the medical image data to a second networked site, according to patient profile data;
(d) providing the medical image data to an authorized viewer at a third site by:
(i) notifying the authorized viewer about the medical image data with an electronic message;
(ii) receiving a request for the medical image data from the authorized viewer; and
(iii) transmitting the medical image data from said second site to the authorized viewer at the third site.

12. A method according to claim 11 wherein the patient profile data comprises data related to health insurance coverage.

13. A method according to claim 11 wherein the patient profile data comprises medical history data.

14. A method according to claim 11 wherein the step of transmitting the medical image data comprises the step of using an internet connection.

15. A method according to claim 11 wherein the authorized viewer is an ophthalmologist.

16. A method according to claim 11 further comprising the step of transferring, from the third site, a diagnostic assessment of patient condition according to the medical image data.

17. A method according to claim 11 wherein the step of obtaining the medical image data at a first networked site further comprises the step of assessing the quality of the medical image data.

18. A method according to claim 11 wherein the step providing the medical image data to an authorized viewer at a third site further comprises the step of providing additional data about the patient.

19. A method according to claim 11 further comprising the step of providing payment information to the patient.

20. A method according to claim 11 further comprising the step of storing the medical image data at a networked site.

21. A method according to claim 11 further comprising the step of notifying the patient about a diagnostic assessment by the authorized viewer.

22. A method for routing medical image data obtained for a patient comprising:
(a) obtaining the medical image for the patient on an image capture apparatus at a first networked site;
(b) obtaining a routing instruction associated with the patient, wherein the routing instruction is accessed from a memory on the image capture apparatus and wherein the routing instruction for the patient may specify any one of a plurality of networked site destinations, according to information obtained from an insurance carrier at a second networked site and from at least a third networked site; and
(c) transmitting the medical image data to a fourth networked site based upon the routing instruction.

23. A method according to claim 22 wherein the step of obtaining the medical image comprises the step of obtaining a retinal image.

24. A method according to claim 22 wherein the routing instruction is generated by a process comprising the steps of:
(i) obtaining data about the patient;
(ii) obtaining information about the insurance carrier; and
(iii) obtaining information about a medical specialist.

25. A method according to claim 22 further comprising the step of notifying the patient about a diagnostic assessment at the fourth networked site.

26. A method according to claim 22 wherein the step of obtaining a routing instruction further comprises the step of accessing a computer storing information about governmental regulations.

27. A method for specifying a routing destination for medical data obtained for a patient at a first site on a network, comprising:
(a) receiving a request over the network for destination instructions, wherein the request identifies a patient and provides at least a first item of patient profile metadata about the patient;
(b) obtaining, over the network, at least a second item of metadata for routing from a medical professional;
(c) obtaining at least a third item of metadata for routing from a second site on the network;
(d) generating a destination instruction for the medical data according to the patient profile metadata, second item of metadata, and third item of metadata; and
(e) transmitting the destination instruction to the first site.

28. A method according to claim 27 wherein said second site is an insurance carrier site.

29. A method according to claim 27 wherein said second site provides data on governmental regulations.

30. A method for routing medical image data obtained at a primary care site to a specialist site along a network, the method comprising:
(a) loading executable code to a logic processor at the primary care site;
(b) identifying the patient to the processor at the primary care site;
(c) executing the executable code from the processor at the primary care site;
(d) obtaining at least one metadata item from a third site;
(e) generating a routing address for the specialist site according to patient metadata and according to the at least one metadata item; and
(f) transmitting the medical image data to the specialist site, according to the routing address.

31. A method according to claim 30 wherein the step of loading executable code comprises the step of loading an object oriented executable program.

32. A method according to claim 30 wherein the step of generating a routing address comprises the step of generating an internet protocol address.

33. A method according to claim 30 wherein the at least one metadata item comprises information about insurance coverage for the patient.

34. A method according to claim 30 wherein the at least one metadata item comprises information about a governmental regulation.

35. A method for dynamically routing medical data related to a patient between sites in a communications network, comprising:
(a) identifying said patient at a first site;
(b) obtaining the medical data about the patient at said first site;
(c) forming a current workflow profile, comprising the steps of:
(i) obtaining a patient profile comprising information associated with the patient;
(ii) obtaining at least one additional profile comprising information associated with the medical data obtained; and
(iii) associating the patient profile with the at least one additional profile, forming said current workflow profile thereby;
(d) processing data in said current workflow profile to determine a preferred receiving site; and
(e) transmitting the medical data to the preferred receiving site.

36. A method according to claim 35 wherein the step of identifying the patient comprises the step of obtaining biometric data from the patient.

37. A method according to claim 35 wherein the step of obtaining the medical data comprises the step of capturing an image.

38. A method according to claim 35 wherein the step of obtaining the medical data comprises the step of capturing a retinal image.

39. A method according to claim 35 wherein the step of building the current workflow profile comprises the step of requesting data from a networked site.

40. A method according to claim 35 wherein the step of processing data in the current workflow profile comprises the step of identifying a plurality of receiving sites in the communications network.

41. A method according to claim 35 wherein the step of obtaining a patient profile comprises the step of accessing data local to the logic processor executing the sequence of steps a) through e).

42. A method according to claim 35 wherein the step of processing the current workflow profile data is performed at a networked site.

43. A method according to claim 35 wherein the step of processing the current workflow profile data is performed at the logic processor executing the sequence of steps a) through e).

44. A method according to claim 35 wherein the step of selecting a preferred receiving site comprises the step of obtaining additional data from a networked site.

45. A method according to claim 35 further comprising the steps of assessing the medical data at the preferred receiving site and, based on the assessment and on the current workflow profile, transmitting the medical data and current workflow profile to a third site.

46. A method according to claim 35 wherein the step of transmitting the medical data comprises transmitting the medical data and current workflow profile data.

47. A method according to claim 35 wherein both the first site and the preferred receiving site are remote sites relative to the control logic processor executing the sequence of steps a) through e).

48. A method according to claim 35 wherein the step of transmitting the medical data comprises the step of sending data using an internet connection.

49. A method according to claim 36 wherein the step of obtaining biometric data from the patient comprises the step of performing a retinal scan.

50. A method according to claim 36 wherein the step of obtaining biometric data from the patient comprises the step of scanning a fingerprint.

51. A method according to claim 36 wherein the step of obtaining at least one additional profile comprises the step of obtaining data about an insurance carrier.

52. A method according to claim 36 wherein the step of obtaining at least one additional profile comprises the step of obtaining data about a governmental regulation.

53. A method according to claim 35 wherein said method occurs in real time.

54. A method for dynamically notifying an authorized viewer about the availability of medical data related to a patient in a communications network, comprising:
(a) obtaining workflow information and associated medical data;
(b) processing the workflow information to identify the authorized viewer;
(c) obtaining viewer profile data comprising information associated with the authorized viewer;
(d) processing the viewer profile to identify a notification method; and
(e) informing the authorized viewer about the availability of the medical image data using the notification method.

55. A method according to claim 54 wherein the step of obtaining workflow information comprises requesting data from a networked site.

56. A method according to claim 54 wherein the step of obtaining workflow information comprises the step of identifying a group of authorized viewers.

57. A method according to claim 54 wherein the step of processing the workflow information comprises requesting additional data about authorized viewers from a networked site.

58. A method according to claim 54 wherein the step of processing the workflow information comprises the step of requesting additional data from a networked site.

59. A method according to claim 54 wherein the step of informing comprises the step of providing an automated voice message.

60. A method according to claim 54 wherein the step of informing comprises the step of providing an electronic mail message.

61. A method according to claim 54 wherein the authorized viewer is an ophthalmic specialist.

62. A method according to claim 54 wherein the step of informing is performed from third networked site.

63. A method according to claim 54 wherein the step of informing comprises the step of transmitting an electronic pager message.

64. A method for dynamically routing, in a communications network, a diagnostic report related to medical data about a patient, the method comprising:
(a) obtaining the diagnostic report and workflow profile data at a first site;
(b) processing data from both the diagnostic report and the workflow profile data to obtain a destination address of a receiving site;
(c) formatting the diagnostic report according to data about the receiving site; and
(d) transmitting the formatted diagnostic report to the receiving site, according to a preferred delivery method obtained from the receiving site.

65. A method according to claim 64 further comprising the step of querying the receiving site to determine the preferred delivery method.

66. A method according to claim 64 wherein the step of formatting the diagnostic report comprises the step of specifying a subset of data from a larger set of obtained data.

67. A method for dynamically routing medical data related to a patient in a communications network, comprising:
(a) obtaining the medical data about the patient at a first site;
(b) transmitting the medical data to a second site to assess if the data is suitable for diagnostic purposes;
(c) reporting results of the assessment to the first site; and
(d) transmitting the medical data to a third site for diagnostic assessment.

68. A method for dynamically notifying a second site in a communications network about the availability of a diagnostic report related to a patient at a first site, the method comprising:
(a) obtaining the diagnostic report at a first site;
(b) forming a current workflow profile, comprising the steps of:
(i) obtaining a patient profile comprising information associated with the patient;
(ii) obtaining at least one additional profile comprising information associated with the diagnostic report obtained; and
(iii) associating the patient profile with the at least one additional profile, forming a current workflow profile thereby;
(c) processing data in the current workflow profile to determine a preferred second site;
(d) obtaining notification profile data associated with the second site; and
(e) notifying the second site about the availability of the diagnostic report according to the notification profile data.

69. A method for dynamically routing medical data related to a patient between sites in a communications network, comprising:
(a) identifying a patient at a first site;
(b) obtaining the medical data about the patient at a first site;
(c) forming a current workflow profile, comprising the steps of:
(i) obtaining a patient profile comprising information associated with the patient;
(ii) obtaining at least one additional profile comprising information associated with the medical data obtained; and
(iii) associating the patient profile with the at least one additional profile, forming a current workflow profile thereby;
(d) processing data in the current workflow profile to determine a preferred receiving site;
(e) obtaining viewer profile data comprising information associated with an authorized viewer at the preferred receiving site;
(f) processing the viewer profile data to identify a notification method;
(g) informing the authorized viewer about the availability of the medical image data using the notification method;
(h) transmitting the medical data to the preferred receiving site;
(i) generating a diagnostic report related to the medical data;
(j) processing data from both the diagnostic report and the workflow profile data to obtain a destination address of a third site;
(k) formatting the diagnostic report according to data about the third site; and
(l) transmitting the formatted diagnostic report to the third site, according to a preferred delivery method obtained from the third site.

70. A method for dynamically routing medical data related to a patient between sites in a communications network, comprising:
(a) identifying a patient at a first site;
(b) obtaining the medical data about the patient at a first site;
(c) forming a current workflow profile, comprising the steps of:
(i) obtaining a patient profile comprising information associated with the patient;
(ii) obtaining at least one additional profile comprising information associated with the medical data obtained; and
(iii) associating the patient profile with the at least one additional profile, forming a current workflow profile thereby;
(d) processing data in the current workflow profile to determine a preferred receiving site;
(e) obtaining viewer profile data comprising information associated with an authorized viewer at the preferred receiving site;
(f) processing the viewer profile data to identify a notification method;
(g) informing the authorized viewer about the availability of the medical image data using the notification method; and
(h) transmitting the medical data to the preferred receiving site.

71. A method for dynamically notifying a second site in a communications network about the availability of a diagnostic report related to a patient at a first site, the method comprising:
(a) obtaining the diagnostic report at a first site;
(b) forming a current workflow profile, comprising the steps of:
(i) obtaining a patient profile comprising information associated with the patient;
(ii) obtaining at least one additional profile comprising information associated with the diagnostic report obtained; and
(iii) associating the patient profile with the at least one additional profile, forming a current workflow profile thereby;
(c) processing data in the current workflow profile to determine a second site for receiving the diagnostic report;
(d) obtaining notification profile data associated with the second site;
(e) notifying the second site about the availability of the diagnostic report according to the notification profile data;
(f) formatting the diagnostic report according to data about the second site; and
(g) transmitting the formatted diagnostic report to the second site, according to a preferred delivery method obtained from the receiving site.

72. A method for dynamically routing medical data related to a patient between sites in a communications network, comprising:
(a) identifying a patient at a first site;
(b) obtaining the medical data about the patient at a first site;
(c) forming a current workflow profile, comprising the steps of:
(i) obtaining a patient profile comprising information associated with the patient;
(ii) obtaining at least one additional profile comprising information associated with the medical data obtained; and
(iii) associating the patient profile with the at least one additional profile, forming a current workflow profile thereby;
(d) processing data in the current workflow profile to determine a preferred receiving site;
(e) obtaining viewer profile data comprising information associated with an authorized viewer at the preferred receiving site;
(f) transmitting the medical data to the authorized viewer at the preferred receiving site;
(g) generating a diagnostic report related to the medical data;
(h) processing data from both the diagnostic report and the workflow profile data to obtain a destination address of a third site;
(i) formatting the diagnostic report according to data about the third site; and
(j) transmitting the formatted diagnostic report to the third site, according to a preferred delivery method obtained from the third site.

73. A system for providing a diagnosis for a patient comprising:
(a) an image capture appliance at a first networked site for obtaining retinal image data from the patient, for obtaining metadata about the patient, and for executing a network transaction for transmitting the retinal image data and metadata to a second networked site;
(b) a remote server in networked communication with the image capture appliance for obtaining the metadata for the patient and for providing the network address of the second site according to the metadata;
(c) a storage resource in communication with the remote server for storing a copy of the transmitted retinal image data; and
(d) a viewing appliance in networked communication with the remote server and in networked communication with the image capture appliance for viewing the transmitted retinal image data according to the routing instructions.

74. A system according to claim 73 wherein the image capture appliance comprises a logic processor for executing instructions downloaded over the network.

75. A system according to claim 73 wherein the image capture appliance is configured by the remote server.
